(19) United States
(12) Patent Application Publication
(10) Pub. No.: US 2026/0219906 A1
(43) Pub. Date: Jul. 30, 2026

(54) VIRTUAL ASSISTANT AVATAR FOR SMART DEVICES

(71) Applicant: Roku, Inc., San Jose, CA (US)

(72) Inventors: Seyed Amir Alavi, Ely (GB); Shashank Merchant, Sunnyvale, CA (US); Ziad Tamim, Cambridge (GB)

(21) Appl. No.: 19/391,935

(22) Filed: Nov. 17, 2025

Related U.S. Application Data
(63) Continuation-in-part of application No. 19/279,741, filed on Jul. 24, 2025.
(63) Continuation-in-part of application No. 19/279,951, filed on Jul. 24, 2025.
(60) Provisional application No. 63/749,854, filed on Jan. 27, 2025.
(60) Provisional application No. 63/749,854, filed on Jan. 27, 2025.

(51) Int. Cl. G06F 9/451; G06F 9/445; H04N 21/47

(52) U.S. Cl. CPC G06F 9/453; G06F 9/4451; H04N 21/47

(57) ABSTRACT

System, apparatus, article of manufacture, method and/or computer program embodiments relate to providing a virtual assistant avatar. An example method can include identifying a user of a device, determining a profile for a virtual assistant avatar associated with the user, the profile for the virtual assistant avatar comprising at least one of a visual component, a voice component, and a behavioral component, selecting an operational mode for the virtual assistant avatar based on a current user interface (UI) context, generating the virtual assistant avatar for the user based on the operational mode and the profile for the virtual assistant avatar associated with the user, and providing the virtual assistant avatar to at least one of a user interface (UI) and the device associated with the user.

### CROSS-REFERENCE TO RELATED APPLICATIONS

This application is a continuation-in-part of U.S. Non-Provisional Patent Application No. 19/279,951, filed on July 24, 2025, and U.S. Non-Provisional Patent Application No. 19/279,741, filed on July 24, 2025, each of which claims the benefit of U.S. Provisional Application No. 63/749,854 filed on January 27, 2025. The entire contents of each of the above-listed applications are incorporated by reference herein.

### BACKGROUND

### Field

This disclosure is generally directed to multimodal human-computer interaction and, more specifically, virtual assistant avatars for smart devices.

### SUMMARY

Provided herein are system, apparatus, article of manufacture, method and/or computer program product embodiments (and/or combinations and/or sub-combinations thereof) relate to providing a virtual assistant avatar. An example system may be configured to identify a user of a device, determine a profile for a virtual assistant avatar associated with the user, the profile for the virtual assistant avatar comprising at least one of a visual component, a voice component, and a behavioral component, select an operational mode for the virtual assistant avatar based on a current user interface (UI) context, generate the virtual assistant avatar for the user based on the operational mode and the profile for the virtual assistant avatar associated with the user, and provide the virtual assistant avatar to at least one of a user interface (UI) and the device associated with the user.

According to some aspects, identifying the user of the device comprises identifying a user profile based on at least one of login information, facial recognition, or voice recognition. The system may further be configured to generate the profile for the virtual assistant avatar based on configuration settings provided by the user, images, voice samples, videos, user watch history, user interactions, or social network information, or other source data associated with the user. The UI context may include a theme, a set of device characteristics for the device associated with the user, and/or an architecture for implementing the virtual assistant avatar

According to some aspects, the current UI context includes a personalized content use case, and the system is further configured to generate personalized content including the virtual assistant avatar and provide the personalized content to at least one of a user interface (UI) and the device associated with the user. In other aspects, the current UI context includes a content discovery use case, wherein the system is further configured to provide at least one content recommendation to the user via the virtual assistant avatar. In other aspects, the current UI context comprises a content filtering use case, wherein the system is further configured to identify content for filtering; generating a content block for the content, wherein the content block includes the virtual assistant avatar; and providing the content block to at least one of a user interface (UI) and the device associated with the user. In some aspects, the device is a media device in a multimedia environment.

### BRIEF DESCRIPTION OF THE FIGURES

The accompanying drawings are incorporated herein and form a part of the specification.

FIG. 1 is a block diagram illustrating an example multimedia environment, according to some examples of the present disclosure.

FIG. 2 is a block diagram illustrating an example media device, according to some examples of the present disclosure.

FIGS. 3A-3C are diagrams illustrating examples of user interfaces for browsing media content, according to some examples of the present disclosure.

FIGS. 4A and 4B are diagrams illustrating additional examples of user interfaces, according to some examples of the present disclosure.

FIGS. 5A and 5B are diagrams illustrating additional use cases for a virtual assistant avatar, according to some examples of the present disclosure.

FIG. 6 is a flowchart diagram illustrating an example method for providing the virtual assistant avatar, in accordance with various aspects of the subject technology.

FIG. 7 illustrates an example computer system that can be used for implementing various aspects of the present disclosure.

In the drawings, like reference numbers generally indicate identical or similar elements. Additionally, generally, the left-most digit(s) of a reference number identifies the drawing in which the reference number first appears.

### DETAILED DESCRIPTION

Users can access and consume media content using media devices such as, for example and without limitation, mobile phones (e.g., smartphones), set-top boxes, computers (e.g., desktop computers, laptop computers, tablet computers, etc.), televisions (TVs), Internet Protocol television (IPTV) devices or receivers, media players, displays or monitors, projectors, video game consoles, smart wearable devices (e.g., smartwatches, smart glasses, head-mounted displays (HMDs), extended reality devices (e.g., virtual reality glasses, augmented reality glasses, mixed reality glasses, virtual reality devices with video passthrough, etc.), single-board computers (SBCs) or system-on-chip (SoC) devices, and Internet-of-Things (IoT) devices, among other devices. The media content can include or encompass digital formats and/or assets such as, for example and without limitation, videos (e.g., live videos, pre-recorded or on-demand videos, streamed videos, TV shows, movies, animated videos, motion graphics videos, live action recordings, video clips, any sequence of video frames or graphics, etc.), video games, audio, text (e.g., closed captions, subtitles, onscreen text, intertitles, superimposed text, and/or any other text content), graphics, video and/or application channels, and/or images, among other types.

For example, a user can use a media device to watch a video available through a content platform. The content platform can include a software application, infrastructure, and/or environment associated with (e.g., that includes, hosts, provides, implements, runs on, corresponds to, can be accessed via, etc.) a streaming service, set-top box, set-top box application or environment, online content delivery network, video game system, media application, media player, video sharing application, web browser, TV (and/or, TV application, operating system, and/or platform), entertainment system, online content service, media channel, content provider, media broadcast system, podcast system, linear content system, media receiver, and/or the like. The video can include, for example, a video (e.g., movie, TV show, podcast, livestream, video stream or feed, video broadcast, video recording, video clip, animated video, etc.), broadcast, video game, video conference, video podcast, etc. The media device can access or stream the video from the content platform or a web browser, access the video from storage, or obtain the video from another device. The media device can display the video on a display of the media device and/or a separate/external display. The user can use the media device, a remote control, and/or an application to manage any settings of the video (e.g., volume, closed caption settings, subtitles, resolution, color settings, brightness levels, etc.), navigate to and/or access other content, control a behavior or functionality of the video (e.g., playback, pause, stop, rewind, record, forward, etc.), etc. The media device can include, obtain, and/or manage content (e.g., videos, images, audio, etc.), channels, applications, settings, input and/or output devices, media functionalities, and/or other features/components, which the user can access via the media device.

The media device may also include a user interface that can be used to access and consume (e.g., view/watch, play/replay, etc.) content, interact with content, select content, navigate content and pages, manage a behavior of a content item, adjust content settings, engage in content experiences, etc. The user interface, as well as the user interface configuration and attributes, can affect the user experience. For example, the configuration of the user interface can affect the level of difficulty for the user to find/discover or identify/navigate content and features/functionalities, search or access content, interact with the user interface or content available through the user interface, navigate the user interface, understand the user interface layout, explore the user interface, etc. A poorly designed user interface can frustrate the content experience of a user, cause a user to lose interest in a content experience and/or an associated content platform, frustrate the ability of a user to navigate or explore the user interface and its content, frustrate the ability of a user to learn or discover features and functionalities available through the user interface, discourage or deter a user from engaging with the user interface and/or associated content, etc.

Various devices include virtual assistants (e.g., a digital assistant or AI assistant) as a part of or aspect of their user interface. A virtual assistant is a software-based agent designed to help users perform tasks or access information often through natural language interaction. They can be used to access device functions, perform user tasks, deliver personalized content and recommendations, and enhance engagement. Many virtual assistants, especially those integrated within smart televisions, streaming devices, and home entertainment platforms, are primarily voice or text systems. These assistants provide functional responses via audio output or minimal on-screen text, but they fail to leverage the visual display of the device as part of the interactive experience. The assistants typically use generic, pre-defined voices and personalities that are identical for all users, offering little to no personalization or emotional engagement. Although such systems may respond to simple commands (e.g., “Play next episode,” “Search for comedies”), they lack persistent presence, contextual awareness, or adaptation to individual preferences. As a result, user engagement is superficial and largely transactional.

The lack of a visual or emotional presence limits user connection and discourages repeated daily use, particularly among families and younger viewers. The viewing screen remains largely static and underutilized by virtual assistants, missing opportunities for engagement, discovery, and monetization. Furthermore, interactions with virtual assistants are generally reactive rather than proactive. For example, virtual assistants are typically called into action using wake-word invocation and do not automatically recognize situations where interaction with a user may be helpful. These virtual assistants tend to be impersonal, passive, and utilitarian, functioning as command-line interfaces rather than companions or adaptive guides.

Provided herein are system, apparatus, device, method (also referred to as a process) and/or computer program product embodiments, combinations and/or sub-combinations thereof (also referred to as “systems and techniques” hereinafter) for providing a personalized, avatar-based virtual assistant for smart devices. Aspects of the subject technology provide for a visually embodied virtual assistant in the form of an animated avatar capable of speech, gesture, and contextual awareness. The virtual assistant avatar allows for an interactive and emotionally engaging relationship between the user and the virtual assistant. The virtual assistant is embodied as a visually expressive avatar that may be generated using a combination of user-provided data, thereby reflecting the user’s desired appearance, behavior, tone, and/or personality.

During account and/or profile setup, the system may allow for the upload of one or more images (e.g., a photo of the user, a pet, a family member, etc.), voice samples, videos, or other content that may be used as source material for generating the virtual assistant avatar. For example, the images and/or videos can be used to generate the visual appearance of the virtual assistant avatar. Similarly, voice samples and/or videos, may be used to generate the voice of the virtual assistant avatar. The voice and appearance of the virtual assistant avatar may be generated using various AI tools during account generation or at a later stage. Accordingly, the voice and appearance of the virtual assistant avatar may be representative of the user, the user’s family members (e.g., kids, partner, parent, etc.) or friends, or other familiar character. For example, the virtual assistant avatar may provide guidance, instruction, or other interaction with the appearance and/or voice of a friend of family member.

Descriptions (textual or spoken), virtual assistant options, or profile configurations may also be provided by the user via one or more multimodal interfaces to synthesize a character that is visually and behaviorally customized for that specific household or individual. Over time, the avatar evolves through machine learning processes that analyze viewing patterns, user engagement, and environmental context. It may adjust its tone, speech, attire, and prompting behavior dynamically (e.g., becoming more casual, festive, or reserved) depending on season, theme, event, user preferences, or learned feedback. The virtual assistant avatar can proactively initiate interactions during idle or search periods, offer conversational recommendations, or appear as part of screensavers, advertisements, or short highlight clips. Distinct avatars can be maintained for multiple household members using voice or image recognition, while privacy and data-processing settings can be user-selected (e.g., local-only versus cloud-synchronized or hybrid modes).

By building a relationship of familiarity and trust, the virtual assistant avatar becomes a recognizable companion rather than a generic voice interface. This relationship increases user engagement and satisfaction by turning routine media navigation into a personalized, humanized experience. The virtual assistant avatar can learn when to speak and when to remain silent, creating a balance between helpfulness and unobtrusiveness. Furthermore, users may be more likely to accept recommendations, explore new features, and spend more time on the platform when guided by a character that “knows” them or that the user is familiar with.

The visual embodiment of the virtual assistant also allows for a variety of additional functionality. For example, new monetization opportunities are enabled through personalized advertising and branded avatar-driven experiences. The virtual assistant also provides new modes for safer viewing and/or filtering of objectionable content. Overall, the invention delivers a human-centered virtual assistant avatar that combines visual embodiment, adaptive intelligence, and contextual personalization to enhance user engagement, comfort, and trust.

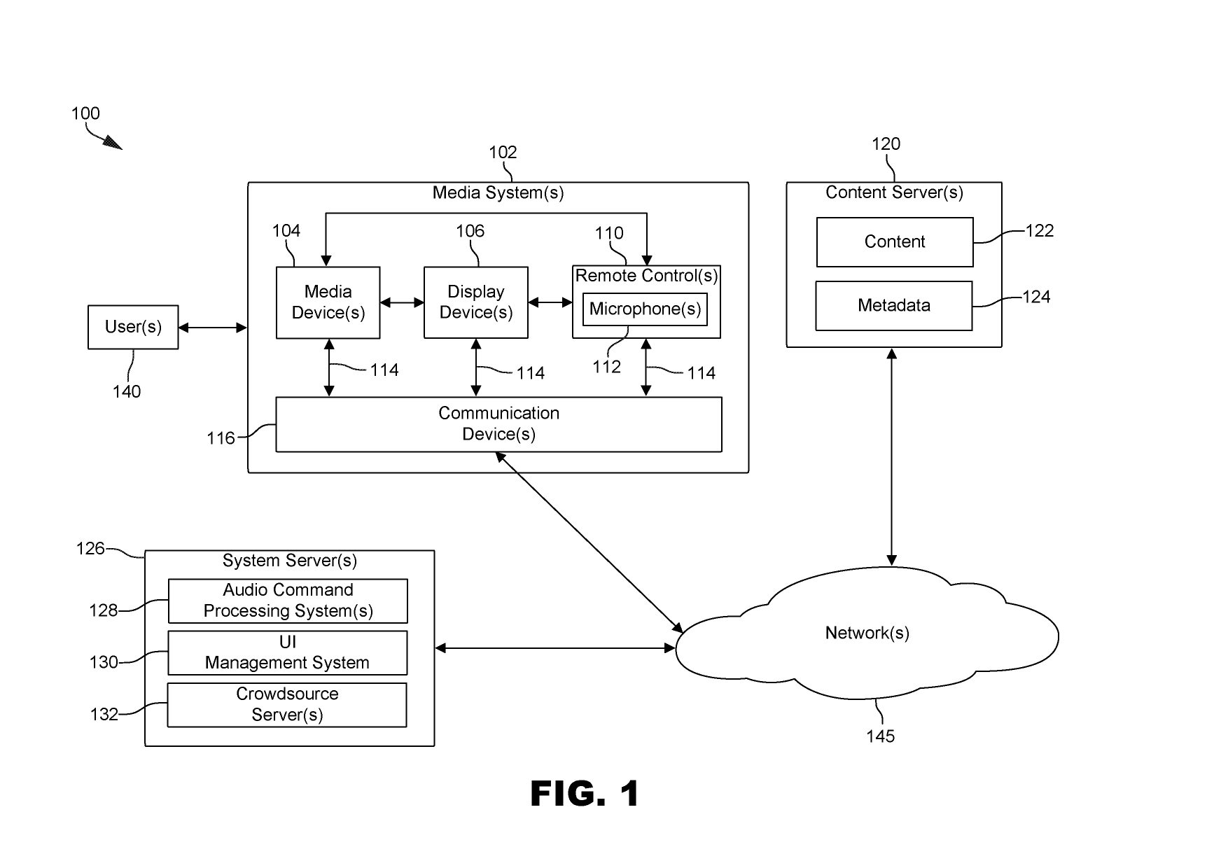

Embodiments and aspects of the disclosure may be part of and/or implemented using multimedia environment 100 shown in FIG. 1. However, multimedia environment 100 is provided for illustrative purposes and is not limiting. Examples and embodiments of this disclosure may be part of and/or implemented using environments that are different from and/or in addition to multimedia environment 100, as will be appreciated by one of skill in the art based on the teachings contained herein. An example of multimedia environment 100 shall now be described.

### Example Multimedia Environment

FIG. 1 is a block diagram illustrating an example multimedia environment 100. In a non-limiting example, multimedia environment 100 may be directed to media content. However, this disclosure is applicable to any type of content (instead of or in addition to media content), as well as any mechanism, means, protocol, method and/or process for distributing content (e.g., media content, etc.), interacting with media content, and/or interacting with media devices. Multimedia environment 100 may include media system(s) 102.

Media system(s) 102 can include one or more media systems, and each media system can include and/or represent a scene or environment and/or one or more devices in a scene or environment. The scene or environment can include, for example and without limitation, a family room, a kitchen, a backyard, a home theater, a school classroom, a library, a car, a boat, a bus, a plane, a movie theater, a stadium, an auditorium, a park, a bar, a conference room, a home, an entertainment room, a restaurant, an office, or any other location or space where it is desired to receive and play media content, such as streaming content. A user(s) 140 may operate media system(s) 102 (and/or one or more devices associated with media system(s) 102) to select/access content (e.g., videos, images, audio, text, user interfaces, application content, etc.), consume content (e.g., watch/view content, play or replay content, interact with content, engage with content, play video game content, etc.), stream content, engage in content interactions or activities, etc. User(s) 140 can include or represent one or more users in multimedia environment 100. The content can include, for example and without limitation, visual content (e.g., movies, television shows and/or programs, images, graphics, visual animations, videos, etc.), audio content (e.g., music, speech or dialogue, sounds, noise, etc.), text content (e.g., subtitles, closed captions, superimposed text or supers, overlaid text, scene text, etc.), metadata, podcasts, application content (e.g., content depicted and/or available via an application, application pages, application menus, etc.), user interfaces and/or user interface content, etc.

Media system(s) 102 may include media device(s) 104, display device(s) 106, remote control(s) 110, communication device(s) 116, and any other device(s). Media device(s) 104 can be coupled to display device(s) 106 and/or can include a display device(s) used to display content. Media device(s) 104 can include one or more media devices, and each media device can be coupled to or include a display device (or multiple display devices). Terms such as “coupled,” “connected to,” “attached,” “linked,” “combined” and similar terms may refer to physical, electrical, magnetic, logical, direct, wired, wireless, etc., connections, unless otherwise specified herein. The one or more media devices can include, for example, one or more streaming devices, DVD or BLU-RAY devices, audio/video playback devices, cable boxes, gaming systems or consoles, televisions, head-mounted displays (HMDs), set-top boxes, video display devices, computers (e.g., laptops, desktops, tablets, etc.), mobile phones, smart wearable devices (e.g., smartwatches, smart glasses, etc.), screens, appliances, internet-of-things (IoT) devices, monitors, single-board computers (SBCs), system-on-chip (SoC) devices, projectors, extended reality (XR) devices (e.g., augmented reality (AR) devices, virtual reality (VR) devices, mixed reality (MR) devices, video-passthrough devices, etc.), and/or digital video recording devices, to name just a few non-limiting examples.

Media device(s) 104 (and/or each media device of media device(s) 104) can include and/or implement and/or be part of, integrated with, operatively coupled to, and/or connected to one or more display devices, such as display device(s) 106 and/or a separate display. Media device(s) 104 may be configured to communicate with network 145 via communication device(s) 116. Communication device(s) 116 may include a cable modem, a satellite television (TV) transceiver, a router, an access point, a network device, an antenna, a gateway, a network switch, a cellular communication device or interface, etc. For example, communication device(s) 116 can include a network device such as a router, switch, gateway, access point, modem, etc. Media device(s) 104 may communicate with communication device(s) 116 over a link. The link may include a wireless (e.g., Wi-Fi, Bluetooth, cellular, etc.) and/or wired connection(s).

Network 145 can include a public, private, cloud, wired, and/or wireless network. For example, network 145 can include the Internet, an intranet, an extranet, a cellular network, a Bluetooth network, an infrared network, a wide area network (WAN), a backbone network, an internet service provider (ISP) network, a network segment, a local area network (LAN), a wireless LAN (e.g., a WIFI network, etc.), an on-premises network, a public and/or private cloud network, and/or any short range, long range, local, regional, global communications mechanism, means, approach, protocol and/or network, or combination(s) thereof.

Display device(s) 106 can include one or more display devices and each display device can include one or more displays, screens, monitors, televisions, projectors, HMDs, XR devices, heads-up devices, any other display and/or presentation devices, and/or the like. In some cases, display device(s) 106 can include one or more media devices and each media device can be coupled to or include a display (or multiple displays). In some examples, display device(s) 106 may include, represent, implement, and/or be part of and/or coupled to one or more monitors, televisions (TVs), displays, screens, computers (e.g., desktop computers, laptop computers, tablet computers, etc.), mobile phones (e.g., smartphones), smart wearable devices (e.g., smart glasses, HMDs, etc.), appliances, IoT devices, SBCs, SoCs, XR devices, set-top boxes, video game consoles, digital media players, home entertainment systems, video display devices, electronic ink (eInk) devices or displays, and/or projectors, to name a few non-limiting examples.

Remote control(s) 110 can include, implement, represent, or be part of any component, apparatus, and/or software for controlling media device(s) 104 and/or display device(s) 106, such as a remote control, an electronic device with remote control software and/or with or coupled to remote control hardware (e.g., a tablet computer, laptop computer, desktop computer, tablet computer, etc.), on-screen control, integrated control button, audio control, input device, peripheral device, touch screen, or any combination thereof. In some examples, remote control(s) 110 can communicate with media device(s) 104 and/or display device(s) 106 using any wireless and/or wired communication link, technology, and/or protocol such as, for example, cellular, Bluetooth, infrared, WIFI, WIFI direct, etc., or any combination thereof. For example, remote control(s) 110 can communicate with media device(s) 104 and/or display device(s) 106 via a wireless connection and/or wireless signals such as a Bluetooth connection and/or signal, a WIFI connection and/or signal, a WIFI direct connection and/or signal, a cellular connection and/or signal, an infrared connection and/or signal, any other wireless connection or signal, or any combination thereof. In some cases, remote control(s) 110 may optionally include a microphone(s) 112. Microphone(s) 112 can record audio such as speech commands, voice commands, dialogue, and/or utterances used to interact with, control, and/or transmit commands and/or data to media device(s) 104 and/or display device(s) 106. Microphone(s) 112 can optionally record other audio as well such as noise, sounds, music, etc. Microphone(s) 112 can include a hardware and/or software components/features (e.g., buttons, settings, functionalities, etc.) that user(s) 140 can use to activate the recording functionality of microphone(s) 112 to record audio.

Multimedia environment 100 may include content server(s) 120 (e.g., content provider(s), channel(s), source(s), platform(s), storage, system, etc.). Content server(s) 120 can include, implement, and/or represent one or more content servers, storage systems, content delivery services, distributed storage systems, content streaming and/or broadcasting systems, etc. Although only one server is shown in FIG. 1, in practice, content server(s) 120 may include any number of content servers. Content server(s) 120 may communicate with other devices via network 145. Content server(s) 120 may store content 122 and metadata 124. Content 122 may include any type of content and/or combination of content such as music, videos, movies, video games, television (TV) programs, multimedia content, TV shows, images, text, graphics, video games, applications, advertisements, programming content, public service content, channels, media, user interface data, user profiles, user avatars, templates, content items, files, targeted content, software, and/or any other content/data and/or objects in electronic form.

Metadata 124 can include data about content 122. For example, metadata 124 may include ancillary information indicating or related to a writer, director, producer, composer, artist, actor, summary, chapters, production, settings, history, year, trailers, alternate versions, related content, application, title, and/or any other information pertaining to content 122. Metadata 124 may also or alternatively include links to such information pertaining to content 122. Metadata 124 may also or alternatively include one or more content indexes, such as but not limited to a trick mode index.

Multimedia environment 100 may include system server(s) 126, which may support media device(s) 104 and/or display device(s) 106 from a remote location and/or network, such as a cloud network, a backend network, a datacenter, etc. The structural and functional aspects of system server(s) 126 may wholly or partially exist in the same or different system servers. In some examples, system server(s) 126 may include, host, operate, and/or implement audio command processing system(s) 128, user interface (UI) management system 130, and/or crowdsource server(s) 132. Audio command processing system(s) 128 can process audio data such as speech/voice inputs and/or commands, audio/speech in videos, etc. For example, remote control(s) 110 may include a microphone(s) 112 that can record audio from user(s) 140 (and/or other sources). In some examples, media device(s) 104 may be audio responsive, and the audio data may represent verbal commands from user(s) 140 to control media device(s) 104 and/or any other components in media system(s) 102, such as display device(s) 106.

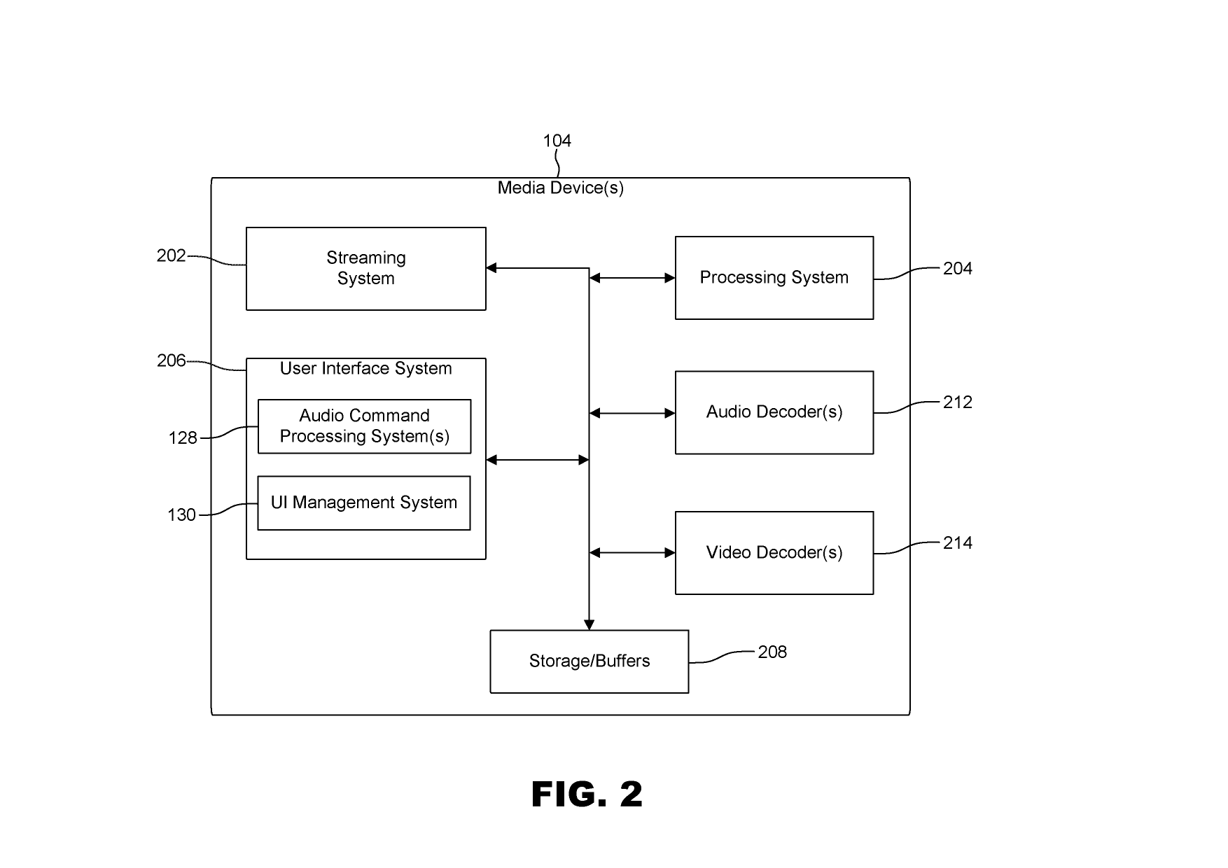

In some examples, the audio data recorded by microphone(s) 112 can be transferred to media device(s) 104, which can forward the audio data (with or without first processing the audio data) to audio command processing system(s) 128. Audio command processing system(s) 128 may process and analyze the audio data to recognize any verbal commands in the audio data. Audio command processing system(s) 128 may forward the verbal commands back to media device(s) 104 for processing. In some cases, the audio data may be alternatively or additionally processed and analyzed by a copy or version of audio command processing system(s) 128 in media device(s) 104 (see FIG. 2). Media device(s) 104 and system server(s) 126 may cooperate to pick any of the verbal commands for processing (e.g., verbal commands recognized by audio command processing system(s) 128 in system server(s) 126 and/or by a copy or version of audio command processing system(s) 128 in media device(s) 104). In some cases, audio command processing system(s) 128 can include, perform, or implement automatic speech recognition (ASR), natural language processing (NLP), natural language understanding (NLU), natural language generation (NLG), text-to-speech generation, etc.

UI management system 130 can select, configure, generate, deliver, and/or customize user interfaces and associated content, settings, behaviors, features, designs, themes, experiences, attributes, etc. The user interfaces can be rendered/displayed by media device(s) 104 and/or display device(s) 106. The user interface content can include any type of content, data, and/or metadata, such as content 122, metadata 124, etc. UI management system 130 can select content and/or metadata for presentation to user(s) 140 via media device(s) 104 and/or display device(s) 106. For example, UI management system 130 can generate, render, configure, manage, and/or provide a user interface(s) for display by media device(s) 104 and/or display device(s) 106.

UI management system 130 can additionally or alternatively generate, configure, and/or provide user interface data that media device(s) 104 and/or display device(s) 106 can use to render, display, generate, configure, and/or implement a user interface(s). The user interface(s) can include and/or can be used to access content, settings, experiences, controls, menus, metadata, user profiles and/or avatars, media, features, UI spaces, content services, etc. For example, UI management system 130 can provide and/or render a user interface(s) or interface data (e.g., used to render, display, generate, and/or configure a user interface) to media device(s) 104 and/or display device(s) 106 for presentation to user(s) 140. User(s) 140 can use the user interface(s) to access, navigate, view, control, engage with, and/or interact with content, content services, UI data, etc.

UI management system 130 can configure the user interface(s) and/or a content, behavior, setting, design, theme, artwork, experience, functionality, and/or feature of the user interface(s) and/or data thereof. The user interface(s) can include a dynamic, static, customized, and/or shared user interface (UI), content experience, UI theme, UI configuration, UI behavior, UI experience, etc. For example, UI management system 130 can configure, adjust, generate, select, and/or customize any content, pages, screens, windows, themes, appearances, designs, immersive experiences, user profiles, avatars, content, interface elements, interface attributes, visual effects, UI styles, UI settings, etc., of user interfaces presented to users.

UI management system 130 can configure, adjust, generate, select, and/or customize such content, pages, screens, windows, features, themes, appearances, experiences, interface attributes, interface settings, etc., based on one or more signals. The one or more signals can include profile data, user interactions, user history, event data (e.g., content release events, current events, promotion events, trending events, cultural events, user and/or device events, news events, competitions, games, content events, group events, social events, etc.), group profile data, activity data, purchase history, statistics, interactions, location information, preferences, inputs, social media signals (e.g., connections, posts, content, feedback, subscriptions, etc.), trends (e.g., social media trends, user ratings, consumption trends, activity trends, etc.), calendar data, temporal cues, sensor data, device data, context data, content or promotion campaigns, content consumption data, historical data, usage patterns, user data, promoted content, statistics, interactions, etc.

UI management system 130 can host, include, execute, represent, and/or be part of one or more software algorithms, neural networks and/or models (e.g., artificial intelligence (AI) and/or machine learning (ML) models, etc.), applications, interfaces (e.g., application programming interfaces (APIs), etc.), code, servers, application services, software containers, virtual machines, software engines, software logic, hardware and/or software resources, etc. For example, UI management system 130 can include an API used to obtain or retrieve data from content server(s) 120 and/or provide data to user devices. UI management system 130 can include software, such as an algorithm(s) and/or model(s) (e.g., an AI/ML model(s), etc.), configured to generate, customize, modify, update, render, manage, and/or configure user interfaces (and associated data, behaviors, experiences, settings, etc.), such as a user interface(s) of a content platform/application. The user interfaces can include, depict, or implement a theme, including related visual attributes, content, immersive experiences, profiles, profile-based experiences, user avatars (e.g., profile images), tailored experiences, features, etc.

In some cases, crowdsource server(s) 132 can turn closed captioning on and/or off during playback/streaming of content, such as a movie. For example, using information received from media device(s) 104 in media system(s) 102 (e.g., in thousands or millions of media systems), crowdsource server(s) 132 may identify similarities and overlaps between closed captioning requests issued by different users watching a movie. Based on such information, crowdsource server(s) 132 may determine that turning closed captioning on may enhance the users’ viewing experience at particular portions of the movie (e.g., when the soundtrack of the movie is difficult to hear), and turning closed captioning off may enhance the users’ viewing experience at other portions of the movie (for example, when displaying closed captioning obstructs important or relevant visual aspects of the movie). Accordingly, crowdsource server(s) 132 may automatically turn closed captioning on and/or off during playback/streaming of content.

In some cases, audio command processing system(s) 128, UI management system 130, and/or crowdsource server(s) 132 can be part of, hosted at, and/or implemented by a same server (or set of servers) from system server(s) 126 or different/separate servers from system server(s) 126. In other cases, UI management system 130 can be part of, hosted at, and/or implemented by a server (or set of servers) that is (or are) separate from a server(s) that includes, implements, and/or hosts audio command processing system(s) 128 and/or crowdsource server(s) 132. In other cases, audio command processing system(s) 128, UI management system 130, and/or crowdsource server(s) 132 can be distributed across multiple and/or different servers.

In some cases, media device(s) 104 can include, implement, and/or host a copy or version of audio command processing system(s) 128 and/or UI management system 130 as shown in FIG. 2. Moreover, audio command processing system(s) 128, UI management system 130, and crowdsource server(s) 132 can each include, implement, be part of, and/or host one or more servers, computers, models and/or neural networks, models (e.g., AI/ML models, statistical models, etc.), algorithms, applications, software engines or modules, code/logic, software components, processors and/or processing circuitry (e.g., central processing units (CPUs), compute resources, application services, software containers, virtual machines, microservices, digital signal processors (DSPs), graphics processing units (GPUs), image signal processors (ISPs), processor cores, system-on-chip (SOC) devices, application-specific integrated circuits (ASICs), field-programmable gate arrays (FPGAs), integrated circuits, etc.), software and/or hardware elements, software platforms, and/or any hardware and/or software components.

FIG. 2 illustrates a block diagram of an example of media device(s) 104. For illustration and explanation purposes, in FIG. 2, media device(s) 104 represents a single media device. However, media device(s) 104 can include multiple media devices. Media device(s) 104 in FIG. 2 may include a streaming system 202, processing system 204, storage/buffers 208, user interface system 206, audio decoder(s) 212, and video decoder(s) 214. User interface system 206 may optionally include a copy or version of audio command processing system(s) 128 to perform some or all of the operations, tasks, functions, and/or actions of audio command processing system(s) 128. Additionally or alternatively, user interface system 206 may optionally include a copy or version of UI management system 130 to perform some or all of the operations, tasks, functions, and/or actions of UI management system 130.

Media device(s) 104 may optionally include a copy or version of audio command processing system(s) 128 and/or UI management system 130 to allow media device(s) 104 to respectively perform any of the tasks, operations, functions, actions, etc., described herein with respect to audio command processing system(s) 128 and/or UI management system 130 (e.g., in addition to or instead of any of such tasks, operations, functions, etc. (or portions thereof), performed by audio command processing system(s) 128 and/or UI management system 130 in/from system server(s) 126 shown in FIG. 1).

In some examples, audio command processing system(s) 128 and/or UI management system 130 can be optionally included in, implemented by, and/or part of the user interface system 206. Alternatively, audio command processing system(s) 128 and/or UI management system 130 can be optionally included in, implemented by, hosted at, and/or part of media device(s) 104, such as processing system 204, or represent one or more separate components.

In some cases, audio command processing system(s) 128 optionally included in media device(s) 104 can be the same as audio command processing system(s) 128 in/from system server(s) 126 in multimedia environment 100 shown in FIG. 1. In other cases, audio command processing system(s) 128 optionally included in media device(s) 104 in FIG. 2 can be a version of audio command processing system(s) 128 in/from system server(s) 126 in multimedia environment 100 shown in FIG. 1, such as a local version, a client version, a standalone version, and/or a lighter version (e.g., a smaller version having a smaller data size; a version with less components, features, functions, modules, libraries, and/or capabilities; a version with less code or a smaller package of code; etc.) of audio command processing system(s) 128 in/from system server(s) 126 in FIG. 1.

In some cases, UI management system 130 optionally included in media device(s) 104 in FIG. 2 can be the same as UI management system 130 in/from system server(s) 126 in multimedia environment 100 shown in FIG. 1. In other cases, UI management system 130 optionally included in media device(s) 104 in FIG. 2 can be a version of UI management system 130 in/from system server(s) 126 in multimedia environment 100 shown in FIG. 1, such as a local version, a client version, a standalone version, and/or a lighter version (e.g., a smaller version having a smaller data size; a version with less components, features, functions, modules, libraries, and/or capabilities; a version with less code or a smaller package of code; etc.) of UI management system 130 in/from system server(s) 126 in FIG. 1.

As shown in FIG. 2, media device(s) 104 may also include one or more audio decoders 212 and one or more video decoders 214. Each audio decoder 212 may be configured to decode audio of one or more audio formats, such as but not limited to AAC, HE-AAC, AC3 (Dolby Digital), EAC3 (Dolby Digital Plus), WMA, WAV, PCM, MP3, OGG GSM, FLAC, AU, AIFF, and/or VOX, to name just some examples. Media device(s) 104 can implement other applicable decoders, such as a closed caption decoder.

Similarly, each video decoder 214 may be configured to decode video of one or more video formats, such as but not limited to MP4 (mp4, m4a, m4v, f4v, f4a, m4b, m4r, f4b, mov), 3GP (3gp, 3gp2, 3g2, 3gpp, 3gpp2), OGG (ogg, oga, ogv, ogx), WMV (wmv, wma, asf), WEBM, FLV, AVI, QuickTime, HDV, MXF (OP1a, OP-Atom), MPEG-TS, MPEG-2 PS, MPEG-2 TS, WAV, Broadcast WAV, LXF, GXF, and/or VOB, to name just some examples. Each video decoder 214 may include one or more video codecs, such as but not limited to, H.263, H.264, H.265, VVC (also referred to as H.266), AVI, HEV, MPEG1, MPEG2, MPEG-TS, MPEG-4, Theora, 3GP, DV, DVCPRO, DVCPRO, DVCProHD, IMX, XDCAM HD, XDCAM HD422, and/or XDCAM EX, to name some examples.

### Personalized Virtual Assistant Avatar

Referring again to FIGS. 1 and 2, UI management system 130 (e.g., at system server(s) 126 and/or media device(s) 106) can generate, render, and/or provide various user interfaces and immersive experiences, including personalized virtual assistant avatars. In the multimedia environment 100, the user interfaces can be used to access content, navigate content, search/find content, play and/or interact with content, engage in content experiences, participate in content activities or immersive interactions, access and/or adjust associated settings, access and/or manage user data such as user profiles, avatar profiles and settings, etc. The content may include any type of content and/or combination of content such as music, videos, movies, video games, television (TV) programs, multimedia content, TV shows, images, text, graphics, video games, applications, advertisements, programming content, public service content, channels, media, user interface data, user profiles, user avatars, templates, content items, files, targeted content, software, and/or any other content/data and/or objects in electronic form.

UI management system 130 can design, generate, configure, and/or personalize user interfaces, experiences, and the virtual assistant avatar based on the current UI context and a profile for a virtual assistant avatar. A UI context is a set of data that can be used to adapt the user interface and virtual assistant avatar to provide a more personalized experience. It represents a current state, situation, or mode of operation for the user interface at a given moment and helps define how the virtual assistant avatar and the interface should behave, appear, and respond based on what is happening on the device or around the user. The UI context can include, for example, a functional use case, a theme, an event, device characteristics, application context, an avatar architecture, a current time (e.g., time of day, week, month, year, etc.), user behavior signals, or other data.

The functional use case may include a purpose or task for the virtual assistant avatar. For example, the virtual assistant avatar may serve content discovery purposes and help a user find content or recommend content to the user. The virtual assistant avatar may also be configured to serve as a companion for the user in whatever activity (e.g., gaming, viewing, shopping, etc.) the user is engaged in or help the user learn about or discovery features of the multimedia environment. The virtual assistant avatar may also integrate with other devices associated with the user and serve as a digital home assistant and/or assist in filtering or blocking certain content for the user.

Themes and events may include, for example, seasonal themes and event (e.g., holidays), promotional events (e.g., Olympics, awards shows, championship matches, movie or series premiers, elections, etc.), an educational event, an advertising event, weather, or other themes and events. According to some aspects, themes and/or events can be scheduled on a calendar for adapting the current UI context.

Device characteristics include the device type (e.g., TV, mobile phone, smart doorbell, smart speaker; digital assistant, smart refrigerator, etc.), device capabilities and specifications (e.g., whether it has a screen, screen size, graphics or processor capability, input types available, etc.), device state (e.g., on, off, sleep state, screen off, etc.), or other device characteristics. The application context can include a state of an application associated with the user interface on which the virtual assistant avatar appears. For example, the application context can include whether the user interface is showing a home screen, media player interface, game interface, search results, settings menu, browsing interface, etc. The avatar architecture may include the implementation architecture for the virtual assistant avatar. For example, the virtual assistant avatar may be cloud-based processing, on-device processing, hub device processing, distributed processing, or a hybrid implementation. Depending on the architecture, different capabilities (e.g., cross-device compatibility, performance, etc.) may be available. The system can enable the user to select a desired architecture based on desired capabilities and features balanced against privacy and data security concerns.

User behavior signals may include past and current user behavior signals such as idle time, browsing loops, repeated back navigation, user disengagement signals (e.g., as captured by cameras or microphones), user interaction history, viewing patterns (e.g., watch history), etc. The user behavior signals may be used to learn user preferences and/or determine when to trigger a prompt from the virtual assistant avatar and determine what may be helpful for the user (e.g., feature education, content recommendation, conversational prompt, etc.). For example, based on user behavior signals, the system may determine that the user is experiencing having difficulty selecting content to view perhaps due to having too many options (e.g., decision paralysis). Accordingly, the virtual assistant avatar may proactively prompt the user by recommending a content item based on the user’s viewing patterns or guide the user to a content selection through interaction.

As noted above, the UI management system 130 is also configured to generate the virtual assistant avatar based on a profile for a virtual assistant avatar. The profile for the virtual assistant avatar may be associated with a user. The UI management system 130 may identify a user based on the user login information, facial recognition via a camera in communication with the media system 102, and/or voice recognition via a microphone 112 in communication with the media system 102. After identifying the user, the UI management system 130 retrieves the virtual assistant avatar profile and uses the profile to generate a virtual assistant avatar.

The virtual assistant avatar profile may include a visual components, a voice components, and a behavioral components. The visual components may include, for example, appearances (e.g., physical characteristics, hair color and length, height, body type, age, facial characteristics, mannerisms, etc.), attires (e.g., outfits, accessories, etc.), and styles. The voice components may include, for example, an acoustic model for the virtual assistant avatar’s voice, timbre, intonation, pitch, volume, rate, accent, vocabulary, speech patterns, catchphrases, etc. The behavioral components may include, for example, personality settings (e.g., friendly, formal, professional, humorous), tone, user prompting frequency or sensitivity, interests (e.g., sports, comedy, news, games, etc.), subject matter expertise, etc.

The virtual assistant profile may be generated derived from user configuration (e.g., during an avatar setup or configuration process), user uploaded content (e.g., images, videos, or voice samples), photo streams, social network information, or verbal descriptions from the user. The virtual assistant profile may also evolve from past interactions, user behavior signals, and feedback. According to various aspects of the subject technology, the UI management system 130 continuously updates the virtual assistant avatar’s profile based on user interaction telemetry (accepted/dismissed prompts, engagement duration, etc.), viewing history and content preferences (e.g., sports, comedy, news), among other things. This allows the virtual assistant avatar to evolve visually and behaviorally, becoming more aligned with the user’s personality and habits over time.

Many aspects of the subject technology provide for cross-device continuity and synchronization that maintain a unified and consistent avatar experience across multiple devices, including televisions, mobile devices and applications, VR or AR systems, doorbells, smart speakers, smart-home hubs, projectors (including holographic projectors), vehicles, and other smart devices or applications. Through a synchronization framework managed by UI management system 130, the system preserves the avatar’s identity, personality, and memory so that the user experiences the same virtual assistant companion regardless of which device is being used. Each virtual assistant avatar is linked to a unique user profile, and its visual, vocal, and behavioral components are synchronized across devices to ensure that the avatar’s tone, gestures, and personality remain consistent.

User interaction history, such as responses to prompts, viewing preferences, actions, and emotional responses (as captured via facial or voice recognition), is processed in a record included in the virtual assistant avatar profile. When a user transitions from one device to another, the UI management system 130 identifies the user based on login information, facial recognition, or voice recognition and retrieves the virtual assistant avatar profile associated with the user to resume conversations or recommendations with contextual continuity and/or provide a consistent experience. In some cases, although the virtual assistant avatar’s identity is consistent, its rendering adapts to the device’s capabilities. For example, a high quality rendering (e.g., 3D and/or high resolution) of the virtual assistant avatar may be generated for capable devices, while simplified renderings (e.g., 2D or lower resolution) may be generated for devices with less processing power, and/or voice-only versions of the virtual assistant avatar may be provisioned on devices without screens (e.g., a speaker device, etc.).

Although various aspects of the subject technology relating to user interfaces and virtual assistant avatars in a multimedia environment are discussed herein, its architecture, techniques, and technologies readily extend to other user interfaces and applications in other environments. The virtual assistant avatar is device-agnostic and can be deployed across different user interfaces, scenarios, use cases, platforms, and environments.

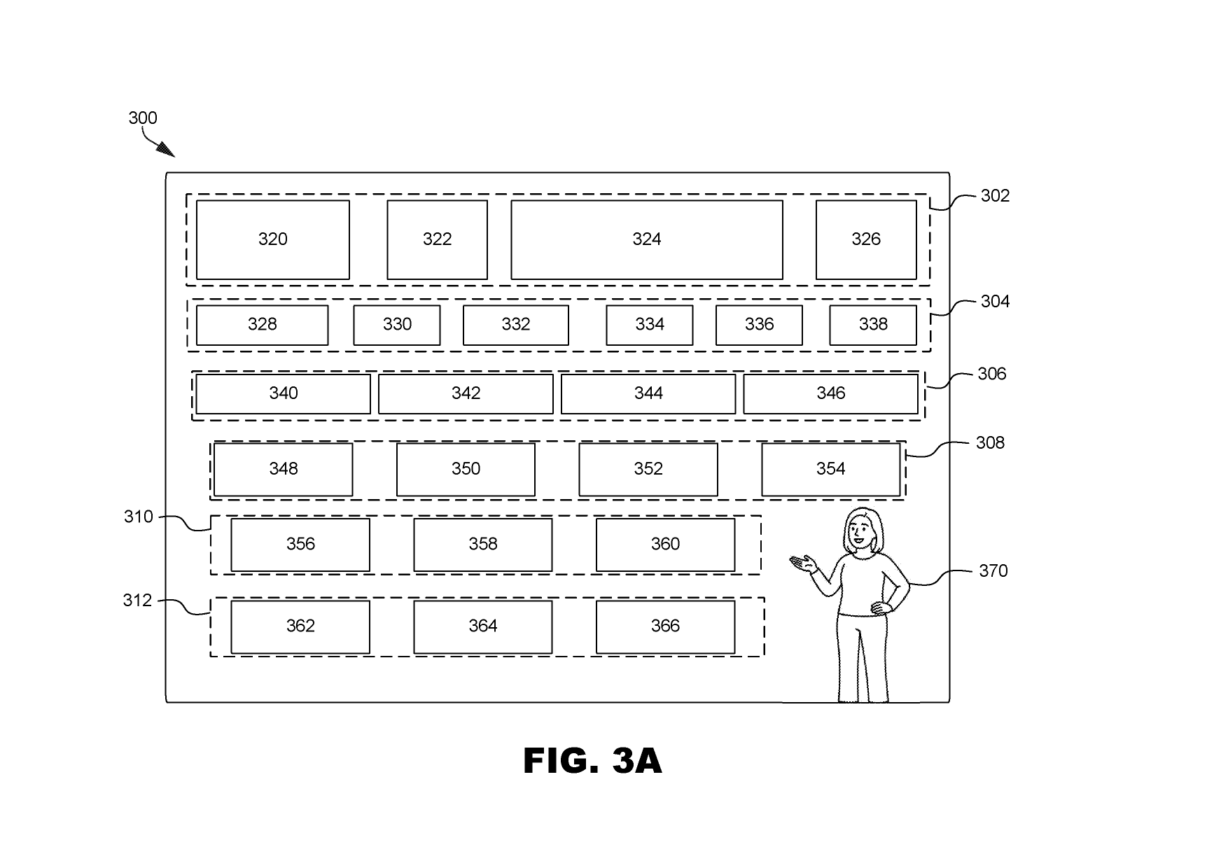

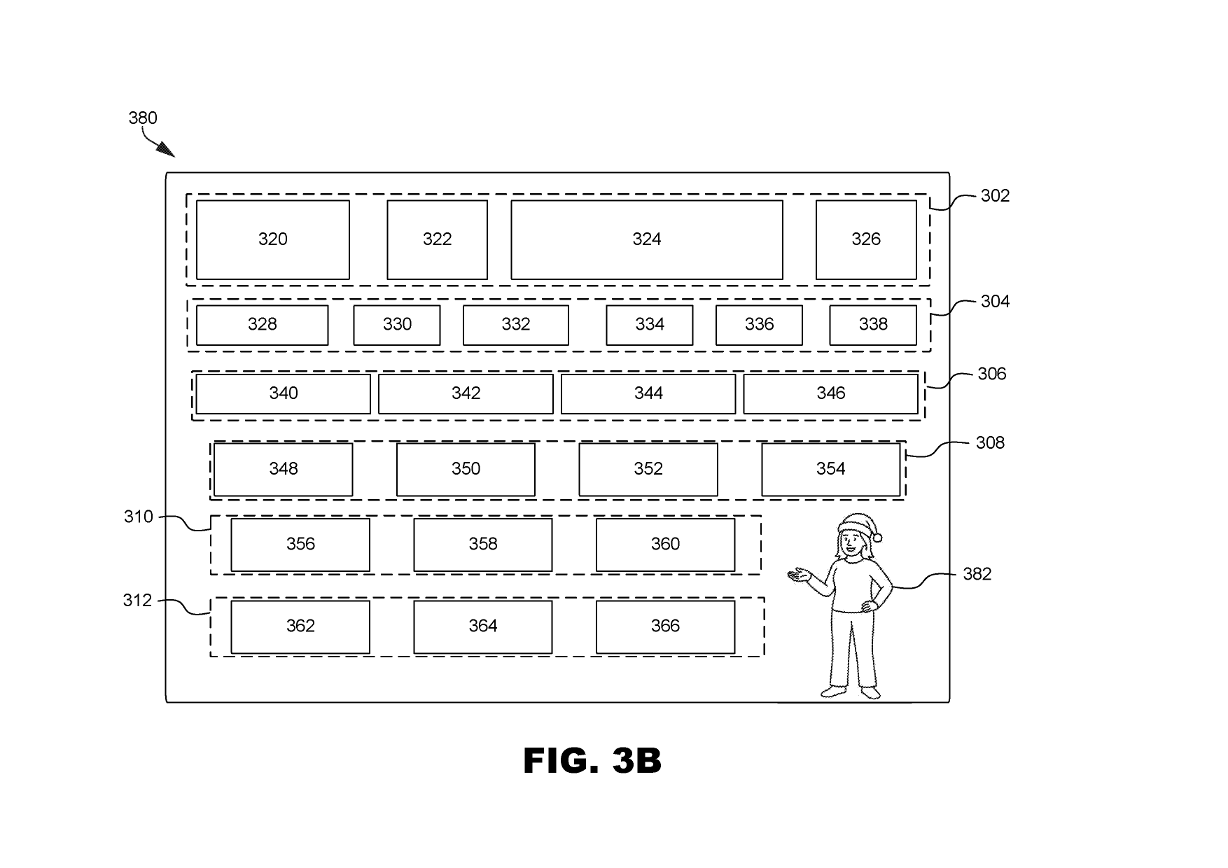

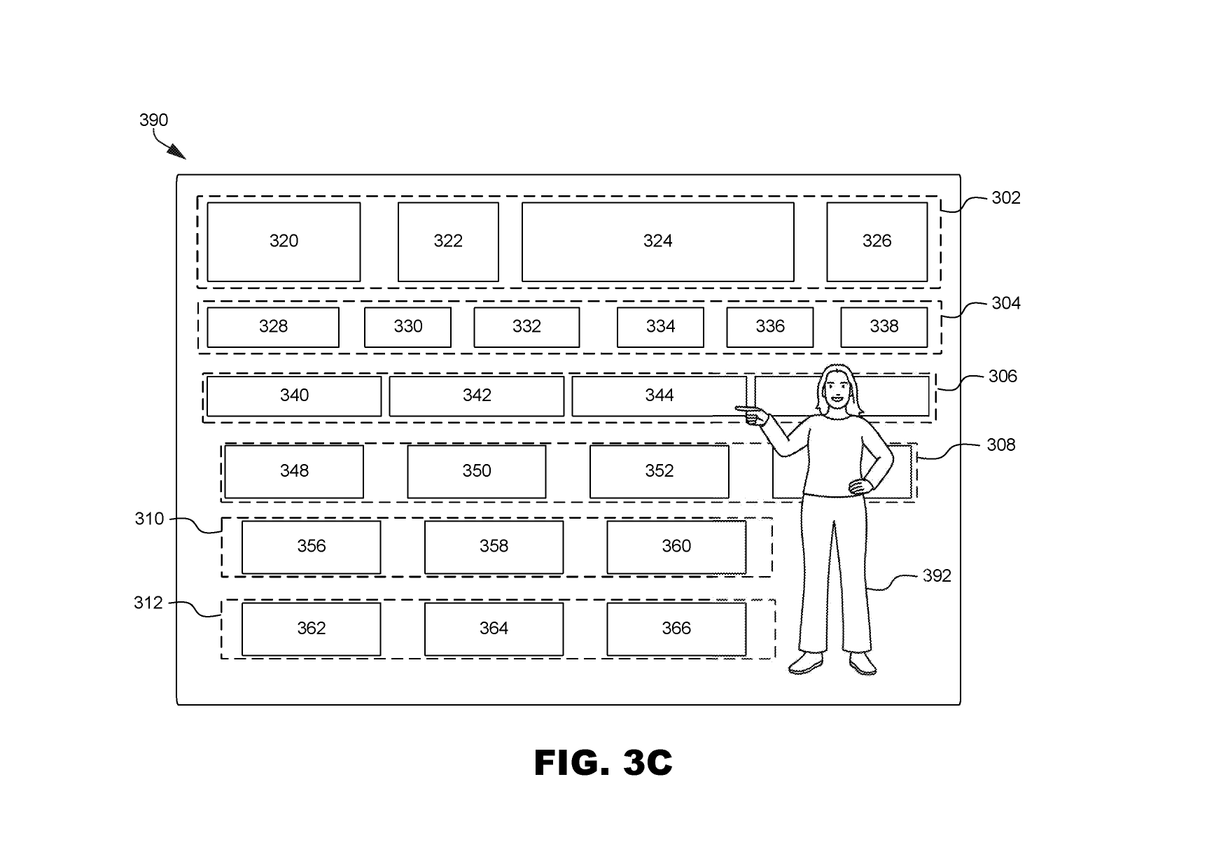

FIGS. 3A-3C are diagrams illustrating examples of user interfaces 300, 380, and 390 for browsing media content, according to some examples of the present disclosure. The user interfaces 300 and 380 for browsing media content may include multiple groups of tiles, such as groups 302, 304, 306, 308, 310, and 312. Each group of tiles may correspond to a content grouping or classification (e.g., a genre, category, collection, or cluster of media content items). In some cases, the layout, positioning, or ordering of each group (and the associated tiles) may be driven by one or more AI/ML model(s) such as, a recommendation engine or personalization model, configured to dynamically customize the user interface 300 experience for a user based on one or more runtime conditions or historical interaction patterns. Moreover, each individual tile of each groups of tiles (e.g., tiles 320, 322, 324, 326, 328, 330, 332, 334, 336, 338, 340, 342, 344, 346, 348, 350, 352, 354, 356, 358, 360, 362, 364, and 366)) may be associated with a respective media content item from the content server(s) 120. In some examples, each tile may be configured to initiate a feature-level interaction such as launching or resuming playback upon user selection or engagement. In some instances, each tile may visually present a graphical representation (e.g., artwork or thumbnail) corresponding to the underlying media content item. Each tile may also be associated with corresponding metadata (e.g., title, genre, recommendation score, etc.) from metadata 124 stored in the content server(s) 120.

According to some aspects, to generate the virtual assistant avatar 370 in the user interface 300 shown in FIG. 3A, the UI management system 130 determines the current UI context for the device. For example, the UI context indicates, among other things, that the user interface 300 for browsing media content is currently displayed by the device. Based on this determination, the system selects an operational mode appropriate for media browsing. In some implementation, this mode allows the avatar to appear in a proactive yet non-intrusive role, assisting with recommendations, helping the user select a media content item, and/or guiding the user through the interface.

The UI management system 130 determines the current UI context for the device also accesses the profile for the virtual assistant avatar associated with the user. This profile includes one or more visual, voice, and behavioral components that have been previously specified, generated, or learned from user-supplied inputs (e.g., uploaded images, voice samples, or configuration settings) and historical interactions. Using these components, the UI management system’s avatar generation module synthesizes an instance of the avatar that visually embodies the user’s preferred appearance and behavior. In some implementations, the avatar’s gestures, facial expressions, and voice characteristics can be adjusted according to the browsing context. For example, the virtual assistant avatar 370 can adopt a conversational posture and friendly demeanor while highlighting or gesturing toward content tiles.

The virtual assistant avatar 370 is then rendered to the user interface 300 by the media system 102, which may integrate the virtual assistant avatar 370 as an overlay element without disrupting the layout of content groups 302 through 312. This visual rendering of the virtual assistant avatar 370 may be synchronized with the content displayed on the screen. In this way, the virtual assistant avatar 370 acts as an intelligent, visually embodied guide rather than a static UI element.

In FIG. 3A, the virtual assistant avatar 370 is shown with an appearance, voice, and behavior consistent with the profile associated with virtual assistant avatar 370 and the current UI context. For example, the virtual assistant avatar 370 is shown talking with the user, perhaps to draw attention to recommended items, to ask questions to help identify content items, and/or to offer contextual suggestions based on metadata such as genre or watch history.

In some cases, changes to the current UI context may affect the visual rendering of a virtual assistant avatar. For example, in FIG. 3B, the virtual assistant avatar 382 in user interface 380 is shown with a different appearance (e.g., full body displayed, slightly smaller in size, with a holiday cap, etc.). Assuming no changes to the profile associated with virtual assistant avatar 382, the change in appearance may be due to changes to the current UI context. For example, the current UI context may include a theme (e.g., elves), a seasonal event (e.g., winter, Christmas holidays, etc.), an event (e.g., an advertising event, a movie premier, etc.), game content, the current zeitgeist, and/or user behavior signals (e.g., the user has just watched one or more movies related to Christmas). The visual rendering of a virtual assistant avatar may also change and/or transform based on a task or intent. For example, in FIG. 3C, the virtual assistant avatar 392 in user interface 390 is shown pointing to tile 344 associated with a media content item being recommended or suggested by the virtual assistant avatar 392.

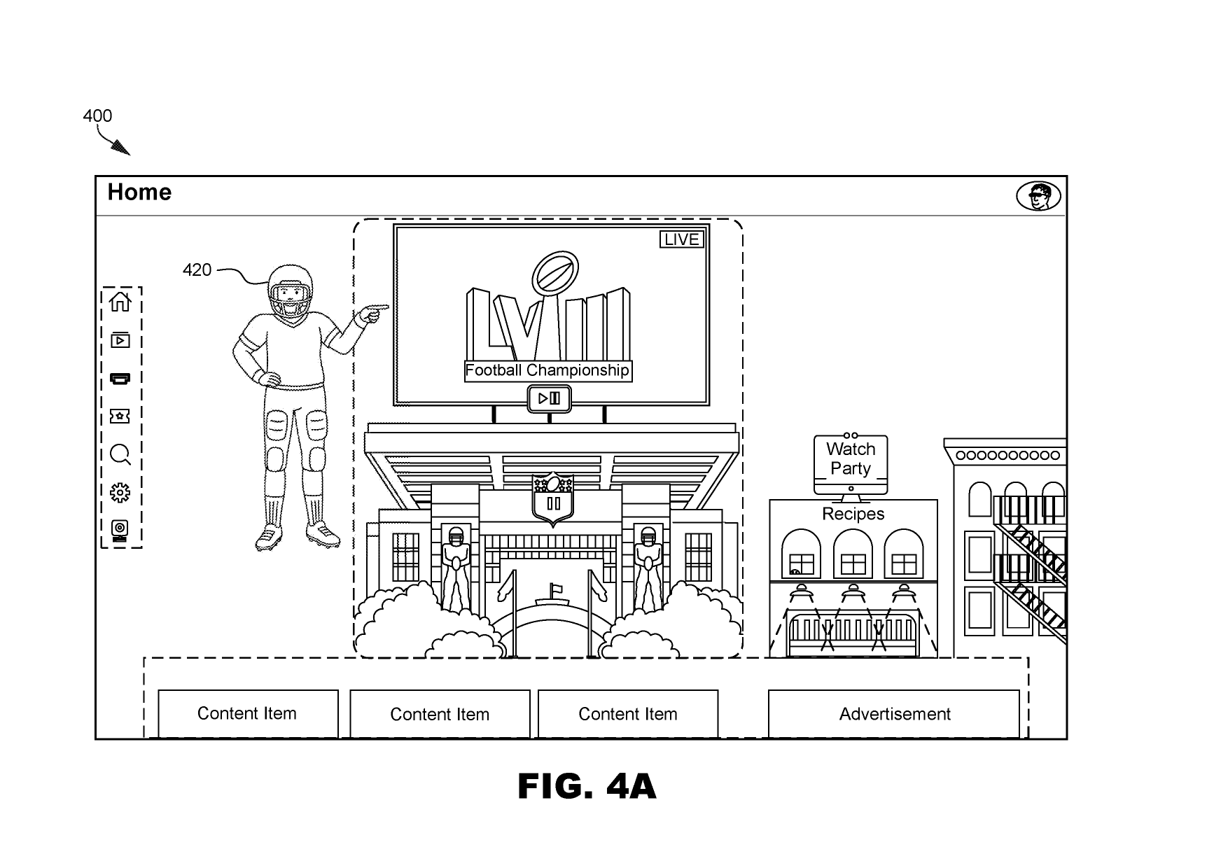

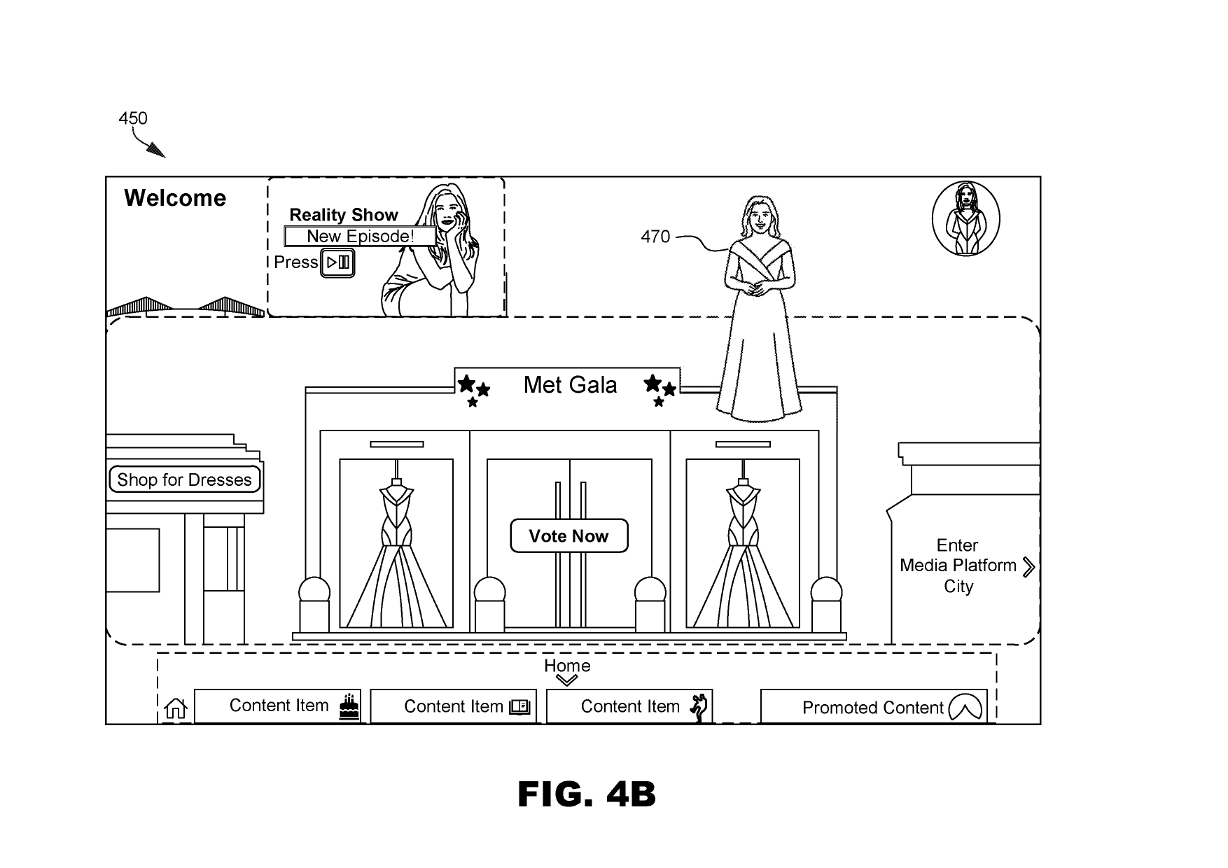

Virtual assistant avatars may also be rendered on other types of user interfaces. For example, FIGS. 4A and 4B are diagrams illustrating additional examples of user interfaces 400 and 450, according to some examples of the present disclosure. The user interfaces 400 and 450 can display, include, and/or represent a page, window, screen, section, area, library, platform, application, portal, and/or interface that includes and/or displays content, features, activities, interface elements, visual elements, etc. The user interfaces 400 and 450 can be used to access and/or navigate content (e.g., media content, interactive/immersive content, static content, dynamic content, etc.), content experiences/activities (e.g., animations, games, immersive experiences, exploration scenes, etc.), etc. The content can include, for example, one or more movies, TV shows, podcasts, videos, broadcasts, live content (e.g., live TV, livestreams, live video feeds, etc.), channels, audio content, media applications, artwork, content libraries and/or catalogs, video games, interactive and/or dynamic content, static content, suggested content, application content, animated content, UI features, streaming content, image content, and/or any other content/features.

In FIGS. 4A and 4B, the user interfaces 400 and 450 have been customed by the UI management system 130 based on themes. Each of the user interfaces 400 and 450 can be used to access, navigate (e.g., search, find, browse, etc.), consume (e.g., watch/view, play, stream, display, etc.), interact with, and manage content, access and engage in content experiences, etc. The user interfaces 400 and 450 can display and/or include content (e.g., media content, interactive content, interface content, etc.) and one or more selected themes.

The selected theme for user interface 400 in FIG. 4A may include a sports theme and, more specifically, a football theme. The football theme is conveyed through various visual elements. For example, the visual elements can include visual elements depicting football imagery, football players or characters, football buildings/structures (e.g., a stadium, a field, etc.), football objects, football symbols, football teams, football information, football team colors, or other football related content (e.g., recipes for a football watch party).

The football theme and details about the user interface 400 are also included in the UI context and used, along with the profile for the virtual assistant avatar, to render the virtual assistant avatar 420. As seen in FIG. 4A, the virtual assistant avatar 420 is rendered wearing a football uniform, in accordance with the football theme. The football uniform may be associated with a favorite team of the user’s, favorite colors of the user, the teams having an upcoming game, and/or teams whose matches are available to watch or are otherwise being promoted.

The behavior of the virtual assistant avatar 420 may also depend on the UI context and the profile for the virtual assistant avatar. For example, the virtual assistant avatar 420 may be configured to promote certain content relating to the theme, direct the user’s attention to an advertisement related to the theme, recommend content associated with the theme, provide education (e.g., a tutorial) on features related to the theme, and/or have a conversation with the user related to the theme.

In FIG. 4B, the selected theme for user interface 450 is a Met Gala theme. The theme is conveyed through various visual elements including features of, from, and/or associated with the Met Gala topic and/or event. The features can include one or more content items, colors, interface elements, visualizations, visualization effects, background elements, animations, attributes, items, graphics, objects, characters, images, renderings, buildings, artwork, and/or details associated with the Met Gala theme. For example, the visual elements in user interface 450 can depict, convey, and/or represent one or more buildings, dresses, symbols, messages, graphics, backgrounds, characters, attributes, colors, symbols, visualizations, visual effects, interface elements, promotions, content items, messages details, and/or artwork associated with the Met Gala topic, event, and/or TV show.

The content items in the user interface 450 may include media content, interactive/immersive content, static content, dynamic content, content experiences/activities (e.g., animations, games, immersive experiences, exploration scenes, etc.), promotional content, advertising content, shopping content, etc. For example, the user interface 450 in FIG. 4B includes tiles to view media content, including promoted content, visual elements that enable shopping functionality, visual elements that enable other interactive content (e.g., submit a vote associated with the Met Gala theme, such as a vote for a content item, character, dress, object, participant, TV show, TV episode, personality, movie, feature, promotion, activity, scene, and/or item associated with the Met Gala theme).

The Met Gala theme and details about the user interface 450 are also included in the UI context and used, along with the profile for the virtual assistant avatar, to render the virtual assistant avatar 470. As seen in FIG. 4B, the virtual assistant avatar 470 is rendered wearing a formal dress, in accordance with the Met Gala theme. The dress may be include the user’s favorite colors (according to the user’s profile and/or the profile of the virtual assistant avatar 470) and/or colors and styles seen on the Met Gala event or TV show.

The behavior of the virtual assistant avatar 470 may also depend on the UI context and the profile for the virtual assistant avatar. For example, the virtual assistant avatar 470may be configured to promote certain content relating to the theme, direct the user’s attention to an advertisement related to the theme, recommend content associated with the theme, provide education (e.g., a tutorial) on features related to the theme, and/or have a conversation with the user related to the theme.

Virtual assistant avatars may be used for a wide variety of functional use cases. For example, the virtual assistant avatar may serve content discovery purposes and help a user find content or recommend content to the user. The virtual assistant avatar may also be configured to serve as a companion for the user in whatever activity (e.g., gaming, viewing, shopping, etc.) the user is engaged in or help the user learn about or discovery features of the multimedia environment. In some variations, in a gaming environment, the virtual assistant avatar may become a playable character, a gaming companion, and/or a gaming opponent. The virtual assistant avatar may also integrate with other devices associated with the user and serve as a digital home assistant and/or assist in filtering or blocking certain content for the user.

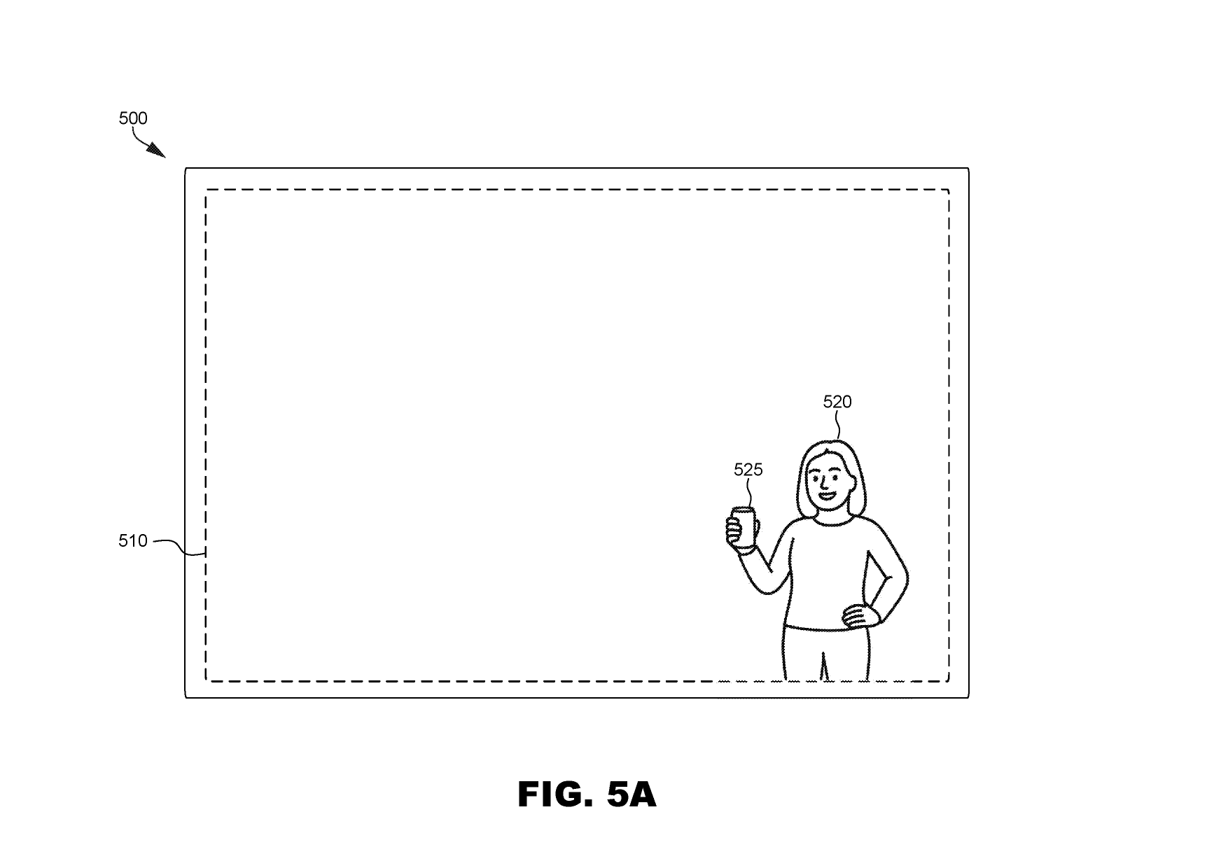

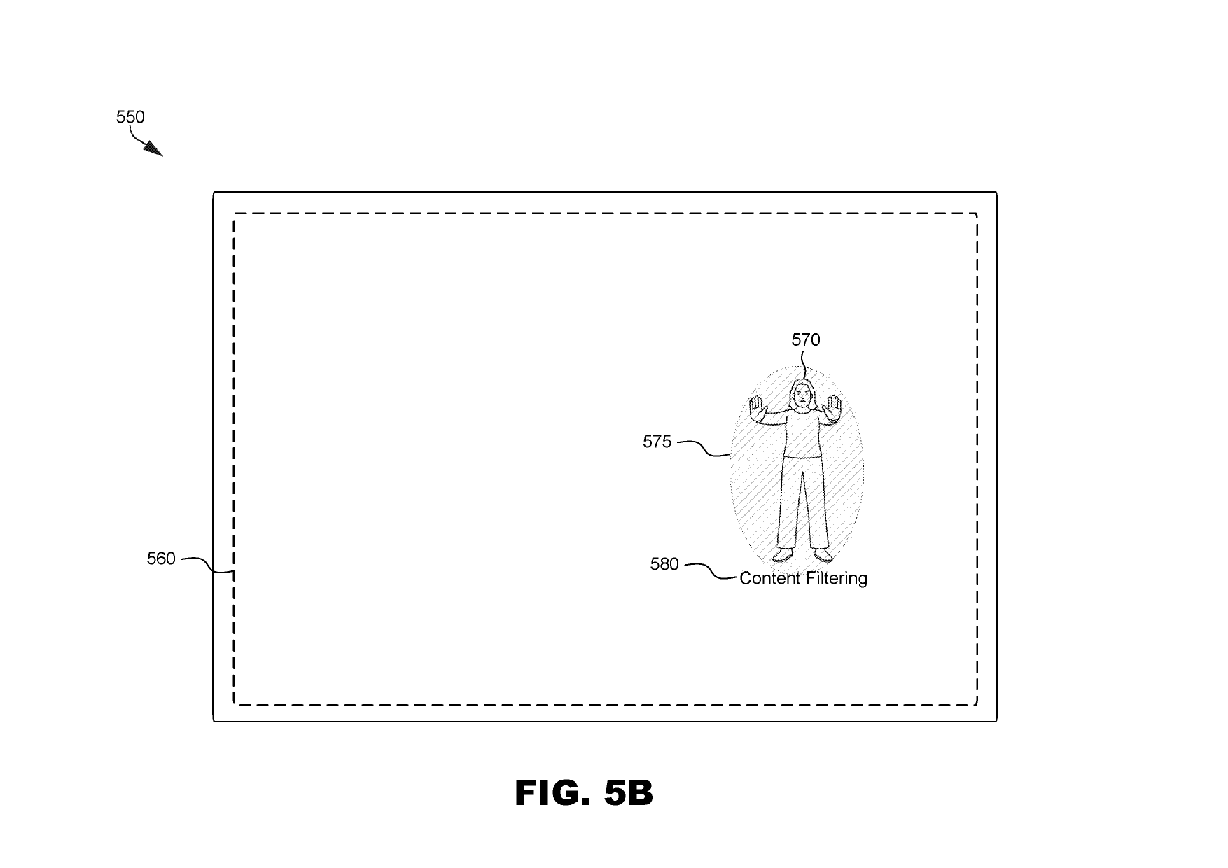

FIGS. 5A and 5B are diagrams illustrating additional use cases for a virtual assistant avatar, according to some examples of the present disclosure. FIG. 5A shows a user interface 500 with a viewing area 510 in which a game can be played, media content can be viewed, and/or an interface (e.g., a control interface, a navigation interface, a monitoring interface, etc.) can be interacted with. The virtual assistant avatar 520 may be generated with a wide variety of different behaviors, appearances, and voice/speech options based on the different use cases included in the UI context, other differences in the UI context itself, and the profile for the virtual assistant avatar 520. For example, in some aspects, the viewing area 510 may display a game being played or a media content being viewed. The virtual assistant avatar 520 may be generated, based on the UI context and virtual assistant avatar profile, as a gaming or watching companion to provide commentary and/or conversation regarding events on screen and/or other topics of interest for the user.

In other aspects, the virtual assistant avatar 520 may be configured, based on the UI context and virtual assistant avatar profile, to provide advertisements in which the virtual assistant avatar 520 introduces, provides, narrates, concludes, and/or is integrated into ad content (e.g., an ad segment). The ad content may be provided in-stream or during an ad break before, after, or during the game play or media content viewing. The virtual assistant avatar’s visual, voice, and behavioral components may be selected from the user’s avatar profile and the current UI context to preserve continuity with prior interactions, while engaging with the user in a different use case. The virtual assistant avatar 520 may deliver a personalized messages (e.g., messages directed to the user and/or using slogans or catchphrases); call out features; and invite an action (e.g., “Add to list,” “Remind me,” “Watch trailer,” or “Buy now”), with actions executed via remote control input, voice confirmation, or a companion device. In some variations, the virtual assistant avatar 520 may appear as a non-blocking overlay that animates, points to, or highlights the relevant ad content while maintaining content visibility.

In the example illustrated in FIG. 5A, the virtual assistant avatar 520 is shown rendered in the viewing area 510 of the user interface 500. The virtual assistant avatar 520 with product placement consistent with a promotional event and/or advertisement content. More specifically, the virtual assistant avatar 520 is shown using a branded prop (e.g., holding a soda can). The virtual assistant avatar 520 may be configured to perform an action with the placed product (e.g., drink the soda can) while performing other functions (e.g., having a conversation with the user, providing commentary, etc.). Additionally, or alternatively, the virtual assistant avatar 520 may be configured to discuss and/or recommend the placed product, wear sponsored apparel, and/or use catchphrases. Additional variations allow for contextual product placement synchronized to content topics or scenes. For example, during a sports summary the virtual assistant avatar 520 can wear the user’s favorite team colors or a sponsored jersey or on a content browsing screen the virtual assistant avatar 520 can place a branded snack on a virtual shelf adjacent to tiles representing movie content items.

In other aspects, the virtual assistant avatar 520 may assist in providing shoppable experiences integrated directly into the browsing UI. For example, the virtual assistant avatar 520 may gesture toward sponsored rows, badges, or tiles, provide recommendations for one or more items, and open a secondary interface with price, availability, and purchasing options. Other themes such as sponsor or advertiser themes, seasonal themes, or event themes may also be used to adapt the attire, background, props, accessories, catchphrases, or speech of the virtual assistant avatar 520.

In other aspects, the virtual assistant avatar 520 may also be configured to deliver notifications, updates, and contextual alerts to the user through visual, auditory, and conversational means that are personalized, context-aware, and non-disruptive to ongoing activities. These functions are coordinated through the UI management system 130, which monitors system events, connected devices, and service integrations to determine when and how the virtual assistant avatar 520 should appear within the user interface to communicate relevant information. In the multimedia environment, the virtual assistant avatar 520 can act as a notification companion within the media interface, providing real-time updates while preserving the continuity of the viewing or browsing experience. For example, when a sports game is underway, the virtual assistant avatar 520 may present important notifications (e.g., close game, near end of game, etc.), replays of key moments, or a highlights clip summarizing key plays or score changes. The virtual assistant avatar 520 may appear in a corner overlay, introduce the update (e.g., “Your team just scored—want to see the replay or switch over to watch?”), and either display the highlight directly or open a tile leading to full playback. Similar highlight summaries and/or notifications may be produced for trending shows, newly released episodes, or recommended content updates, with the virtual assistant avatar 520 narrating or gesturing toward the relevant tiles as part of a content discovery or feature education use case.

In other scenarios, the notifications, updates, and contextual alerts are related to the smart home environment. For example, the UI management system 130 may receive status data from connected devices such as doorbells, thermostats, air quality monitors, cameras, carbon-monoxide detectors, and fire alarms, and translate these inputs into notifications. For instance, when a doorbell camera detects a visitor, the virtual assistant avatar 520 may appear on-screen, look toward the edge of the display, and say, “Someone is at your front door,” optionally showing a live thumbnail feed. If a thermostat reports that home temperature exceeds a threshold, the virtual assistant avatar 520 might present a subtle message like, “It’s warmer than usual. Should I lower the setting?” For maintenance or safety alerts, such as an expiring air-filter schedule or a carbon-monoxide warning, the virtual assistant avatar’s 520 tone and visual demeanor adapt to the urgency of the event. For example, a calm conversational prompt may be used for minor reminders while a prominent gesture, color change, a more urgent tone, or attention animation combined with an audible warning may be used for critical alerts. The UI management system 130 may also escalate notifications using additional communication channels (e.g., pushing a corresponding alert to the user’s mobile device) while ensuring that urgent safety messages override nonessential media output.

According to some aspects, the virtual assistant avatar’s 520 presentation and timing are governed by contextual rules and learned user preferences. When the device is idle, the virtual assistant avatar 520 may present a summary digest (e.g., daily highlights, weather forecasts, or system notifications) using short conversational exchanges or animated visual cards. While content is being consumed and/or interacted with, less intrusive methods may be used, such as smaller display areas, minimal gestures, or a brief overlay that disappears automatically if ignored. The virtual assistant avatar’s 520 frequency and tone are dynamically adjusted based on prior interactions and annoyance thresholds recorded by the system, ensuring that it remains helpful without interrupting the viewing experience. These contextual rules and user preferences may be stored in the virtual assistant avatar profile.

According to various aspects of the subject technology, a virtual assistant avatar may be configured to assist in content filtering and parental control functions by visually, audibly, or contextually moderating the display of identified content within the user interface or playback environment. The identified content may include, for example, sensitive content, private content, personal information, objectionable content, obscene content, violent content, content that is not age appropriate, or other content that may be identified for filtering.

As an illustrative example, in FIG. 5B, the user interface 550 includes a viewing area 560 on which sensitive or restricted content has been detected by the UI management system 130. In response, the virtual assistant avatar 570 is rendered within a visually distinct region 575 (shown as a shaded overlay area) indicating that a filtering operation is in progress. In this example, the virtual assistant avatar 570 may be depicted with raised hands or a blocking gesture, symbolizing that it is actively shielding or obscuring objectionable content from view. The shaded region 575 may correspond to a dynamic overlay, blur, or masking layer that visually replaces or covers the restricted scene while maintaining continuity in playback. In some variations, the shaded region 575 may be accompanied with text 580 (e.g., “Content Filtering”) that provides a notification to the viewer, informing them that a sensitive segment is being filtered according to the content-moderation preferences and/or the reason for the content filtering (e.g., “Sensitive Content Detected”). Accordingly, the virtual assistant avatar 570 can visually participate in enforcing content filtering functions and act as an interactive visual intermediary that communicates the reason for the temporary block, reinforcing transparency and maintaining an emotionally consistent user experience. The virtual assistant avatar’s 570 gestures, expressions, and tone may vary depending on the context (e.g., playful for child profiles, neutral for general use), thereby making content filtering more intuitive and user-friendly within the multimedia environment.

The operation of content filtering functions may be dictated by the virtual assistant avatar profile, one or more user profiles, device settings, user selections, and/or other settings (e.g., parental controls, family or home content settings, etc.). For example, the UI management system 130 identifies the presence of a user or viewer profile (e.g., a child) by means of facial or voice recognition, user logins, or device proximity data. Based on the active profile and configured parental control settings, the UI management system 130 determines whether the currently displayed or upcoming media contains content classified as inappropriate or restricted, such as scenes of violence, explicit language, or mature themes. This determination may be derived from metadata, real-time content analysis, or external content-rating data sources.

As an illustrative scenario, a child’s user profile may indicate that content that is not age appropriate is to be filtered. When the child is detected (e.g., through login information, facial recognition, or voice recognition), the content filtering operations may be dictated by the child’s user profile settings. Alternatively, or additionally, an adult’s or parent’s user profile or device settings may indicate that sensitive content is to be filtered only when children are present. The media system 102 may monitor the environment for children when content is being viewed using connected cameras, microphones, or other presence sensing devices. When a child is detected, the UI management system 130 may cause sensitive content to be filtered.

In some cases, before the identified content appears in the viewing area 560, the virtual assistant avatar 570 may issue a polite warning such as, “The next scene contains violence. Would you like me to skip it?” If the user elects to block the content, the avatar may perform a visual masking gesture, such as covering the screen area with its hand, generating a blur or overlay effect, or substituting neutral imagery until the sensitive segment has concluded. In other variations, the virtual assistant avatar 570 may fade into the corner of the screen and provide a textual or spoken notice (e.g., “Skipping restricted content”) while playback is automatically advanced.

The virtual assistant avatar’s 570 behavior in filtering mode may also be contextually adaptive. For instance, when a child enters the room, the avatar can detect this change through camera input or profile switching and automatically enable child-safe mode, muting or obscuring inappropriate content. Conversely, if an adult user resumes control, the avatar may request authorization to restore normal playback. The virtual assistant avatar’s 570 tone, expressions, and gestures in these scenarios are designed to maintain a friendly, non-intrusive demeanor consistent with its learned personality for that household.

Additionally, the virtual assistant avatar 570 may act proactively before playback begins, summarizing potential sensitivities found in the selected media. For example, it may announce, “This movie contains scenes of violence and strong language. Would you like me to filter them?” Users can configure the virtual assistant avatar 570 to block specific categories such as nudity, gore, or profanity, or to merely provide warnings while preserving the viewing experience. These actions can be governed by household profiles, time-of-day restrictions, or network-level parental control policies.

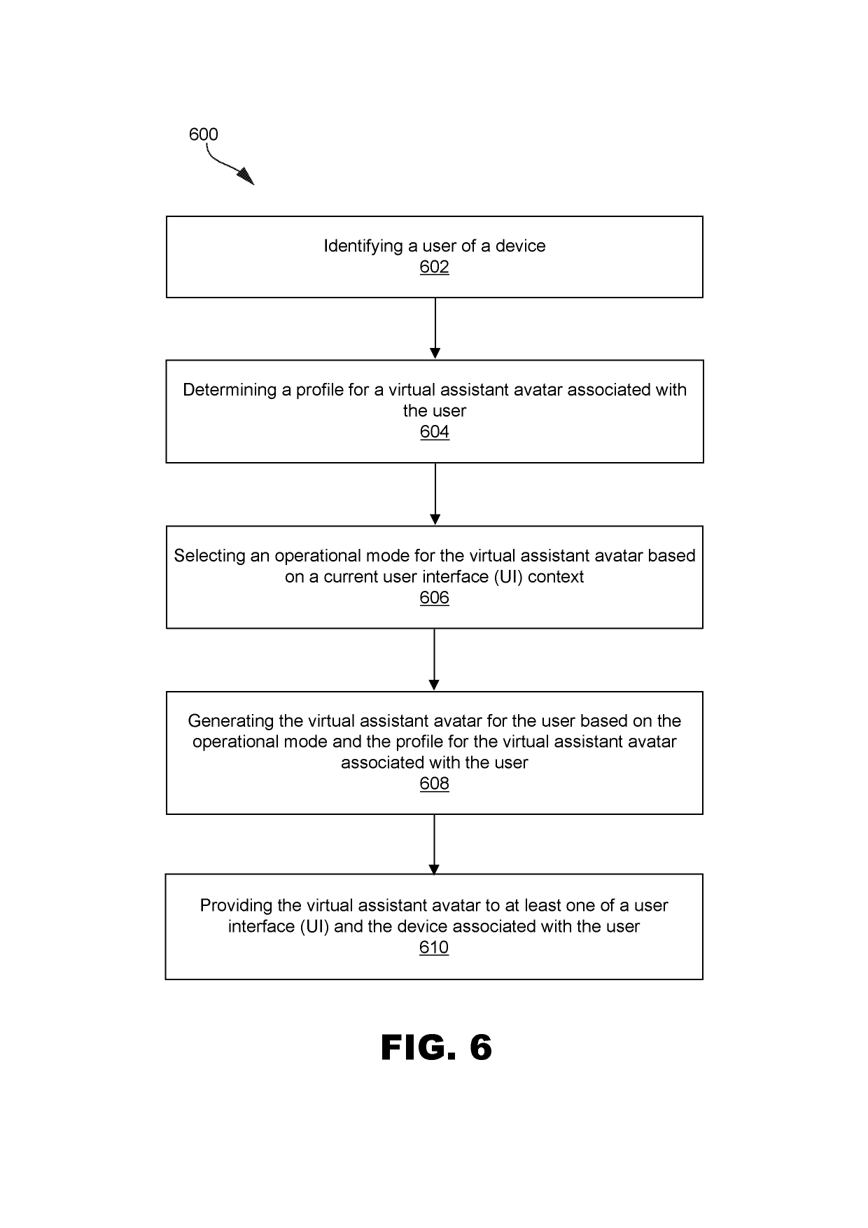

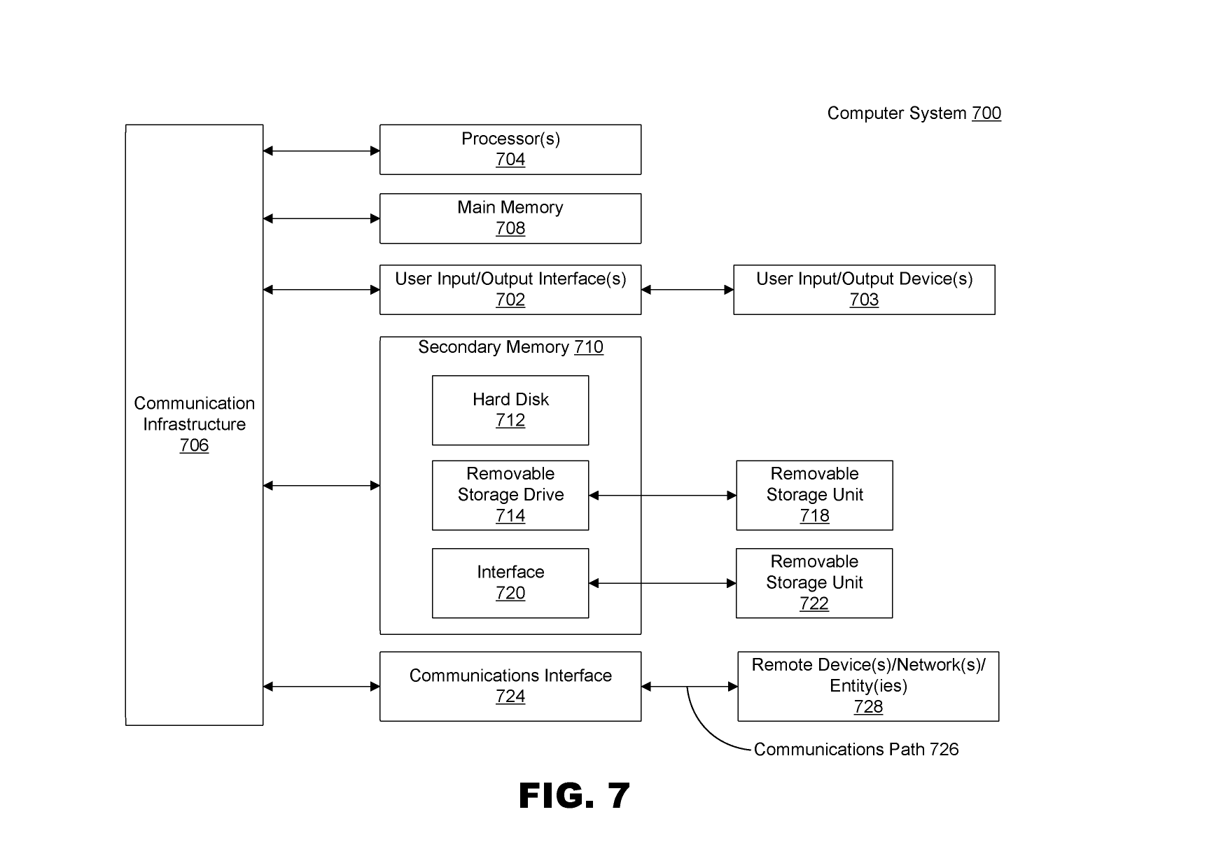

FIG. 6 is a flowchart diagram illustrating an example method 600 for providing the virtual assistant avatar, in accordance with various aspects of the subject technology. The method 600 can be performed by processing logic that can include hardware (e.g., circuitry, dedicated logic, programmable logic, microcode, etc.) and/or software (e.g., instructions executing on a processing device). It is to be appreciated that not all steps may be needed to perform method 600. Some of the steps may be performed simultaneously, or in a different order than shown in FIG. 6, as will be understood by a person of ordinary skill in the art. The method 600 shall be described with reference to FIGS. 1 and 2. However, the method 600 is not limited to those examples.

At step 602, where a UI management system identifies a user of a device. The device may be, for example, a media system, a smart home device, or any other device capable of supporting a virtual assistant avatar. The identification may be performed through login information, an active user profile, facial recognition, or voice recognition. In a multiuser household, this step allows the system to distinguish between family members so that each user can be associated with a distinct avatar configuration.

At step 604, the UI management system determines or retrieves a profile for a virtual assistant avatar associated with the identified user. The avatar profile may include at one or more visual components, voice components, and behavioral components. The visual component defines the virtual assistant avatar’s appearance or attire, the voice component defines tone and speech characteristics, and the behavioral component defines emotional style, personality traits, and interaction tendencies. The avatar profile can be generated from user supplied data (e.g., such as uploaded images, voice samples, avatar configuration settings, or text descriptions) or learned over time from watch history, user interactions, and social context.

At step 606, the system selects an operational mode for the avatar based on a current user interface (UI) context. The UI context defines, among other things, the functional or environmental conditions in which the avatar will operate. For example, the UI context includes uses cases such as content browsing, advertising, gaming, feature education, or content filtering. The UI context may also reflect the device’s capabilities (e.g., a TV vs. a mobile device), the user’s selected architecture (local, cloud, or hybrid), or a thematic condition such as a seasonal event, promotional campaign, or educational setting. This ensures that the avatar’s appearance, gestures, and dialogue are appropriate to both the current activity and the presentation environment.

At step 608, the UI management system generates the virtual assistant avatar for the user based on both the operational mode and the profile for the virtual assistant avatar. The UI management system synthesizes a visual and behavioral representation aligned to the context. For instance, in a content discovery mode, the avatar may appear beside content tiles to recommend shows. In a content filtering mode, the avatar may warn or block objectionable scenes. In a gaming mode, it may act as a companion or commentator and in an advertising mode, it may deliver personalized promotional messages or product placements. The UI management system can also adapt the visual and behavioral representation of the virtual assistant avatar based on themes, events, or other data associated with the UI context. The generation step may incorporate real-time adaptation from a large language model (LLM) reasoning engine to adjust tone, expressions, and dialogue dynamically according to the user’s mood and recent engagement.

At step 610, the UI management system provides the virtual assistant avatar to at least one of a user interface (UI) or the device associated with the user. This delivery step involves rendering or deploying the avatar within the live interface such as on a television display, mobile companion app, or other connected smart device using an overlay or embedded display technique. The virtual assistant avatar may be presented as an on-screen character that visually gestures, speaks, or interacts with interface elements in real time. In some variations, multiple virtual assistant avatars associated with the user may be available, and the system may select the most suitable avatar from that set based on the active operational mode or context.

Accordingly, aspects of the subject technology provide for visually embodied, emotionally engaging companions that enhance user interaction and satisfaction. By combining AI-driven personalization with a context-aware user interface, the system enables adaptive behavior that reflects user preferences and current events and themes. The virtual assistant avatar’s ability to learn and evolve over time fosters trust, familiarity, and long-term engagement, while its proactive guidance shortens the time users spend searching for content and improves discoverability. The technology also introduces new monetization and educational opportunities through interactive, avatar-led advertising and tutorials. Cross-device synchronization ensures a consistent experience across TVs, mobile apps, and smart-home devices, while privacy controls and local-first processing provide user autonomy and data protection.

### Example Computer System

Aspects and examples described herein may be implemented using one or more computer systems, such as computer system 1400 shown in FIG. 14. For example, media device(s) 106, display device(s) 106, content server(s) 120, system server(s) 126, UI management system 130, and/or any other device may be implemented using computer system 1400 (or combinations or sub-combinations thereof). Computer system 1400 may include one or more processors (e.g., central processing units (CPUs)), such as processor 1404. Processor 1404 may be connected to communication infrastructure 1406 (or communication bus). Computer system 1400 may include input/output device(s) 1403, such as monitors, keyboards, pointing devices, etc., which may communicate with communication infrastructure 1406 through user input/output interface(s) 1402.

In some cases, the one or more processors 1404 may include a graphics processing unit (GPU). A GPU can include a processor that is a specialized electronic circuit designed to process mathematically intensive applications. The GPU may have a parallel structure for efficient, parallel processing of data, such as mathematically intensive data common to computer graphics applications, images, videos, etc. The one or more processors 1404 may additionally or alternatively include or be part of a digital signal processor (DSP), an image signal processor (ISP), an application-specific integrated circuit (ASIC), a field-programmable gate array (FPGA), an integrated circuit, a microcontroller, and/or any other processing device.

Computer system 1400 may include a main or primary memory 1408, such as random-access memory (RAM). Memory 1408 may include one or more levels of cache. Main memory 1408 may have stored therein control logic (e.g., computer software) and/or data. Computer system 1400 may also include one or more secondary storage devices or memory 1410. Secondary memory 1410 may include, for example, a hard disk drive 1412 and/or a removable storage device or drive 1414. Removable storage drive 1414 may be a floppy disk drive, magnetic tape drive, compact disk drive, optical storage device, tape backup device, and/or other storage device/drive.

Removable storage drive 1414 may interact with a removable storage unit 1418. Removable storage unit 1418 may include a computer usable or readable storage device having stored thereon computer software (control logic) and/or data. Removable storage unit 1418 may be a floppy disk, magnetic tape, compact disk, DVD, optical storage disk, and/ any other computer data storage device. Removable storage drive 1414 may read from and/or write to removable storage unit 1418. Secondary memory 1410 may include other means, devices, components, instrumentalities or approaches for allowing computer programs, instructions, and/or data to be accessed by computer system 1400. Such means, devices, components, instrumentalities or other approaches may include, for example, a removable storage unit 1422 and an interface 1420. Examples of the removable storage unit 1422 and the interface 1420 may include a program cartridge and cartridge interface (such as that found in video game devices), removable memory chip (e.g., EPROM, PROM, etc.) and associated socket, memory stick and USB or other port, memory card and associated card slot, and/or any removable storage and associated interface.

Computer system 1400 may include a communication or network interface 1424. Communication interface 1424 may enable computer system 1400 to communicate and interact with any combination of external devices, external networks, external entities, etc. (individually and collectively referenced by reference number 1428). For example, communication interface 1424 may allow computer system 1400 to communicate with external or remote devices 1428 over communications path 1426, which may be wired and/or wireless (or a combination thereof), and which may include any combination of LANs, WANs, the Internet, etc. Control logic and/or data may be transmitted to and from computer system 1400 via communication path 1426.

Computer system 1400 may also be any of a personal digital assistant (PDA), desktop workstation, laptop or notebook computer, netbook, tablet, mobile phone (e.g., smartphone), smart watch or other wearable, appliance, part of the Internet-of-Things, and/or embedded system, to name a few non-limiting examples, or any combination thereof.

Computer system 1400 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, formats, and schemas in computer system 1400 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Proprietary data structures, formats or schemas may be used, either exclusively or in combination with known or open standards.

In some cases, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 1400, main memory 1408, secondary memory 1410, and removable storage units 1418 and 1422, as well as tangible articles of manufacture embodying any combination of the foregoing. Such control logic, when executed by one or more data processing devices (such as computer system 1400 or processor(s) 1404), may cause such data processing devices to operate as described herein.

Based on the teachings contained in this disclosure, it will be apparent to one of skill in the relevant art how to make and use embodiments of this disclosure using computer and processing devices, systems, and architectures other than those described herein, which can operate with software, hardware, and/or operating system implementations other than those described herein.

### Conclusion

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating implementations of specified functions and relationships thereof. The boundaries of these functional building blocks have been defined herein for the convenience of the description. Alternate boundaries can be defined as long as the specified functions and relationships (or equivalents thereof) are appropriately performed. Alternative embodiments can perform functional blocks, steps, operations, methods, etc. using orderings different than those described herein.

References to “one embodiment,” “an embodiment,” “an example embodiment,” or similar phrases indicate that the embodiment may include a particular feature, structure, or characteristic, but every embodiment may not necessarily include that feature, structure, or characteristic. Moreover, such phrases are not necessarily referring to the same embodiment. When a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

### Illustrative examples of the disclosure include:

Aspect 1. A system comprising: memory; and one or more processors are coupled to the memory and configured to perform operations comprising: identifying a user of a device; determining a profile for a virtual assistant avatar associated with the user, the profile for the virtual assistant avatar comprising at least one of a visual component, a voice component, and a behavioral component; selecting an operational mode for the virtual assistant avatar based on a current user interface (UI) context; generating the virtual assistant avatar for the user based on the operational mode and the profile for the virtual assistant avatar associated with the user; and providing the virtual assistant avatar to at least one of a user interface (UI) and the device associated with the user.

Aspect 2. The system of aspect 1, wherein identifying the user of the device comprises identifying a user profile based on at least one of login information, facial recognition, or voice recognition.

Aspect 3. The system of aspect 1, wherein the operations further comprise generating the profile for the virtual assistant avatar based on configuration settings provided by the user.

Aspect 4. The system of aspect 1, wherein the operations further comprise generating the profile for the virtual assistant avatar based on at least one of images, voice samples, videos, or other source data associated with the user.

Aspect 5. The system of aspect 1, wherein the operations further comprise generating the profile for the virtual assistant avatar based on at least one of user watch history, user interactions, or social network information associated with the user.

Aspect 6. The system of aspect 1, wherein the operations further comprise: selecting a theme based on an event calendar comprising events for adapting the current UI context; and wherein the current UI context comprises the theme.

Aspect 7. The system of aspect 6, wherein the events comprise at last one of a seasonal event, a promotional event, an educational event or an advertising event.

Aspect 8. The system of aspect 1, wherein the current UI context comprises a set of device characteristics for the device associated with the user.

Aspect 9. The system of aspect 1, wherein the current UI context comprises an architecture for implementing the virtual assistant avatar, and wherein the architecture is selected by the user.

Aspect 10. The system of aspect 1, wherein the current UI context comprises a personalized content use case, wherein the operations further comprise: generating personalized content including the virtual assistant avatar; and providing the personalized content to at least one of a user interface (UI) and the device associated with the user.

Aspect 11. The system of aspect 1, wherein the current UI context comprises a content discovery use case, wherein the operations further comprise providing at least one content recommendation to the user via the virtual assistant avatar.

Aspect 12. The system of aspect 1, wherein the current UI context comprises a content filtering use case, wherein the operations further comprise: identifying content for filtering; generating a content block for the content, wherein the content block includes the virtual assistant avatar; and providing the content block to at least one of a user interface (UI) and the device associated with the user.

Aspect 13. The system of aspect 1, wherein the device is a media device in a multimedia environment.

Aspect 14. A computer-implemented method comprising: determining a profile for a virtual assistant avatar associated with a user, the profile for the virtual assistant avatar comprising at least one of a visual component, a voice component, and a behavioral component; selecting an operational mode for the virtual assistant avatar based on a current user interface (UI) context; generating the virtual assistant avatar for the user based on the operational mode and the profile for the virtual assistant avatar associated with the user; and providing the virtual assistant avatar to a user interface (UI) associated with the user.

Aspect 15. The method of aspect 1, further comprising generating the profile for the virtual assistant avatar based on configuration settings provided by the user.

Aspect 16. The method of aspect 1, further comprising generating the profile for the virtual assistant avatar based on at least one of images, voice samples, videos, or other source data associated with the user.

Aspect 17. The method of aspect 1, further comprising generating the profile for the virtual assistant avatar based on at least one of user watch history, user interactions, or social network information associated with the user.

Aspect 18. The method of aspect 1, wherein the current UI context comprises a personalized content use case, wherein the method further comprises generating personalized content including the virtual assistant avatar; and providing the personalized content to at least one of a user interface (UI) and the device associated with the user.

Aspect 19. The method of aspect 18, wherein the personalized content is an advertisement.

Aspect 20. A non-transitory computer-readable medium having instructions stored thereon that, when executed by one or more processors, cause the one or more processors to perform operations comprising: identifying a user of a device; determining a profile for a virtual assistant avatar associated with the user, the profile for the virtual assistant avatar comprising at least one of a visual component, a voice component, and a behavioral component; generating the virtual assistant avatar for the user based on a current user interface (UI) context and the profile for the virtual assistant avatar associated with the user; and providing the virtual assistant avatar to at least one of a user interface (UI) and the device associated with the user.

What is claimed is:

1. A system comprising:
memory; and
one or more processors are coupled to the memory and configured to perform operations comprising:
identifying a user of a device;
determining a profile for a virtual assistant avatar associated with the user, the profile for the virtual assistant avatar comprising at least one of a visual component, a voice component, and a behavioral component;
selecting an operational mode for the virtual assistant avatar based on a current user interface (UI) context;
generating the virtual assistant avatar for the user based on the operational mode and the profile for the virtual assistant avatar associated with the user; and
providing the virtual assistant avatar to at least one of a user interface (UI) and the device associated with the user.

2. The system of claim 1, wherein identifying the user of the device comprises identifying a user profile based on at least one of login information, facial recognition, or voice recognition.

3. The system of claim 1, wherein the operations further comprise generating the profile for the virtual assistant avatar based on configuration settings provided by the user.

4. The system of claim 1, wherein the operations further comprise generating the profile for the virtual assistant avatar based on at least one of images, voice samples, videos, or other source data associated with the user.

5. The system of claim 1, wherein the operations further comprise generating the profile for the virtual assistant avatar based on at least one of user watch history, user interactions, or social network information associated with the user.

6. The system of claim 1, wherein the operations further comprise:
selecting a theme based on an event calendar comprising events for adapting the current UI context; and
wherein the current UI context comprises the theme.

7. The system of claim 6, wherein the events comprise at last one of a seasonal event, a promotional event, an educational event or an advertising event.

8. The system of claim 1, wherein the current UI context comprises a set of device characteristics for the device associated with the user.

9. The system of claim 1, wherein the current UI context comprises an architecture for implementing the virtual assistant avatar, and wherein the architecture is selected by the user.

10. The system of claim 1, wherein the current UI context comprises a personalized content use case, wherein the operations further comprise:
generating personalized content including the virtual assistant avatar; and
providing the personalized content to at least one of a user interface (UI) and the device associated with the user.

11. The system of claim 1, wherein the current UI context comprises a content discovery use case, wherein the operations further comprise providing at least one content recommendation to the user via the virtual assistant avatar.

12. The system of claim 1, wherein the current UI context comprises a content filtering use case, wherein the operations further comprise:
identifying content for filtering;
generating a content block for the content, wherein the content block includes the virtual assistant avatar; and
providing the content block to at least one of a user interface (UI) and the device associated with the user.

13. The system of claim 1, wherein the device is a media device in a multimedia environment.

14. A computer-implemented method comprising:
determining a profile for a virtual assistant avatar associated with a user, the profile for the virtual assistant avatar comprising at least one of a visual component, a voice component, and a behavioral component;
selecting an operational mode for the virtual assistant avatar based on a current user interface (UI) context;
generating the virtual assistant avatar for the user based on the operational mode and the profile for the virtual assistant avatar associated with the user; and
providing the virtual assistant avatar to a user interface (UI) associated with the user.

15. The method of claim 1, further comprising generating the profile for the virtual assistant avatar based on configuration settings provided by the user.

16. The method of claim 1, further comprising generating the profile for the virtual assistant avatar based on at least one of images, voice samples, videos, or other source data associated with the user.

17. The method of claim 1, further comprising generating the profile for the virtual assistant avatar based on at least one of user watch history, user interactions, or social network information associated with the user.

18. The method of claim 1, wherein the current UI context comprises a personalized content use case, wherein the method further comprises generating personalized content including the virtual assistant avatar; and providing the personalized content to at least one of a user interface (UI) and the device associated with the user.

19. The method of claim 18, wherein the personalized content is an advertisement.

20. A non-transitory computer-readable medium having instructions stored thereon that, when executed by one or more processors, cause the one or more processors to perform operations comprising:
identifying a user of a device;
determining a profile for a virtual assistant avatar associated with the user, the profile for the virtual assistant avatar comprising at least one of a visual component, a voice component, and a behavioral component;
generating the virtual assistant avatar for the user based on a current user interface (UI) context and the profile for the virtual assistant avatar associated with the user; and
providing the virtual assistant avatar to at least one of a user interface (UI) and the device associated with the user.
